(19) United States
(12) Patent Application Publication
(10) Pub. No.: US 2025/0321101 A1
(43) Pub. Date: Oct. 16, 2025

(54) Physical Quantity Detection Device And Method Of Manufacturing Physical Quantity Detection Device

(71) Applicant: SEIKO EPSON CORPORATION, Tokyo (JP)

(72) Inventor: Shogo SASAKI, Matsumoto (JP)

(21) Appl. No.: 19/175,376

(22) Filed: Apr. 10, 2025

(30) Foreign Application Priority Data
Apr. 11, 2024 (JP) 2024-063825
Feb. 17, 2025 (JP) 2025-023206

(51) Int. Cl. G01C 19/5663

(52) U.S. Cl. CPC G01C 19/5663

(57) ABSTRACT

A physical quantity detection device includes a physical quantity detection element, a support substrate, and a circuit device. The physical quantity detection element includes a first detection arm including a first detection electrode and a second detection electrode, and a second detection arm including a third detection electrode and a fourth detection electrode. A detection circuit of the circuit device includes a first amplifier circuit to which a first detection signal from the first detection electrode and a fourth detection signal from the fourth detection electrode are input, and a second amplifier circuit to which a third detection signal from the third detection electrode and a second detection signal from the second detection electrode are input. The support substrate includes first wiring, second wiring, third wiring, and fourth wiring coupled to the first detection electrode, the second detection electrode, the third detection electrode, and the fourth detection electrode, respectively. On the support substrate, the second wiring is coupled to ground during inspection and coupled to the third wiring during operation, and the fourth wiring is coupled to the ground during the inspection and coupled to the first wiring during the operation.

The present application is based on, and claims priority from JP Application Serial Number 2024-063825, filed Apr. 11, 2024, and JP Application Serial Number 2025-023206, filed Feb. 17, 2025, the disclosures of which are hereby incorporated by reference herein in their entireties.

### BACKGROUND

### 1. Technical Field

The present disclosure relates to a physical quantity detection device and a method of manufacturing the physical quantity detection device.

### 2. Related Art

JP-A-2015-184124 discloses a physical quantity detection device in which detection sensitivity is improved by inputting detection signals from both positive and negative electrodes of a detection arm to a detection circuit without grounding one of the positive and negative electrodes.

However, in the physical quantity detection device disclosed in JP-A-2015-184124, in order to input a detection signal from a first detection electrode of a first detection arm and a detection signal from a fourth detection electrode of a second detection arm to a first amplifier circuit, the first detection electrode of the first detection arm and the fourth detection electrode of the second detection arm are electrically coupled. In addition, in order to input a detection signal from a second detection electrode of the first detection arm and a detection signal from a third detection electrode of the second detection arm to a second amplifier circuit, the second detection electrode of the first detection arm and the third detection electrode of the second detection arm are electrically coupled. Therefore, since it is not clear whether an unnecessary signal was generated from the first detection arm or the second detection arm, it is not possible to individually measure the vibration characteristics of the first detection arm and the second detection arm. For this reason, appropriate balance tuning or the like cannot be implemented, and it is difficult to improve the performance of the physical quantity detection device.

### SUMMARY

An aspect of the present disclosure relates to a physical quantity detection device including: a physical quantity detection element including a plurality of detection arms, a plurality of drive arms, and a base portion; a support substrate that supports the physical quantity detection element at the base portion; and a circuit device including a detection circuit that detects a physical quantity based on a plurality of detection signals from the plurality of detection arms of the physical quantity detection element. The physical quantity detection element includes, as the plurality of detection arms, a first detection arm including a first detection electrode and a second detection electrode and extending from the base portion, and a second detection arm including a third detection electrode and a fourth detection electrode and extending from the base portion in a direction opposite to a direction in which the first detection arm extends from the base portion. The detection circuit of the circuit device includes an amplifier circuit in which, during operation, a first detection signal from the first detection electrode and a fourth detection signal from the fourth detection electrode are input to a first input node, and a third detection signal from the third detection electrode and a second detection signal from the second detection electrode are input to a second input node. The support substrate includes first wiring having one end coupled to the first detection electrode, second wiring having one end coupled to the second detection electrode, third wiring having one end coupled to the third detection electrode, and fourth wiring having one end coupled to the fourth detection electrode. The second wiring is coupled to ground during inspection and coupled to the third wiring during the operation on the support substrate, and the fourth wiring is coupled to the ground during the inspection and coupled to the first wiring during the operation on the support substrate.

Another aspect of the present disclosure relates to a method of manufacturing a physical quantity detection device including a physical quantity detection element including a plurality of detection arms, a plurality of drive arms, and a base portion, a support substrate that supports the physical quantity detection element at the base portion, and a circuit device including a detection circuit that detects a physical quantity based on a plurality of detection signals from the plurality of detection arms of the physical quantity detection element. The physical quantity detection element includes, as the plurality of detection arms, a first detection arm including a first detection electrode and a second detection electrode and extending from the base portion, and a second detection arm including a third detection electrode and a fourth detection electrode and extending from the base portion in a direction opposite to a direction in which the first detection arm extends from the base portion. The detection circuit of the circuit device includes an amplifier circuit in which, during operation, a first detection signal from the first detection electrode and a fourth detection signal from the fourth detection electrode are input to a first input node, and a third detection signal from the third detection electrode and a second detection signal from the second detection electrode are input to a second input node. The support substrate includes first wiring having one end coupled to the first detection electrode, second wiring having one end coupled to the second detection electrode, third wiring having one end coupled to the third detection electrode, and fourth wiring having one end coupled to the fourth detection electrode. The method includes: preparing the physical quantity detection element and the support substrate; attaching the physical quantity detection element to the support substrate; adjusting at least one of the plurality of drive arms; cutting coupling between the second wiring and ground and coupling between the fourth wiring and the ground; and coupling the second wiring to the third wiring and coupling the fourth wiring to the first wiring.

### BRIEF DESCRIPTION OF THE DRAWINGS

FIG. 1 is a cross-sectional view illustrating an example of a configuration of a physical quantity detection device according to an embodiment.

FIG. 2 is a diagram for explaining operation of a physical quantity detection element.

FIG. 3 is a diagram illustrating an example of a configuration of a circuit device.

FIG. 4 is an explanatory diagram of an amplifier circuit.

FIG. 5 is a signal waveform diagram for explaining operation of the amplifier circuit.

FIG. 6 is an explanatory diagram of an amplifier circuit.

FIG. 7 is a plan view of the physical quantity detection element.

FIG. 8 is a plan view of a support substrate as viewed from an upper surface side.

FIG. 9 is a plan view of the support substrate as viewed from the upper surface side.

FIG. 10 is a plan view of the support substrate as viewed from a lower surface side.

FIG. 11 is a diagram schematically illustrating wiring coupling during inspection.

FIG. 12 is a diagram schematically illustrating wiring coupling during operation.

FIG. 13 is a plan view of the support substrate in a second wiring example as viewed from the upper surface side.

FIG. 14 is a plan view of the support substrate in the second wiring example as viewed from the lower surface side.

FIG. 15 is a diagram schematically illustrating wiring coupling in the second wiring example during the inspection.

FIG. 16 is a diagram schematically illustrating wiring coupling in the second wiring example during the operation.

FIG. 17 is an explanatory diagram of cutting traces.

FIG. 18 is an explanatory diagram of an arrangement relationship between the cutting traces, pads, the physical quantity detection element, and the circuit device.

FIG. 19 is a flowchart illustrating a method of manufacturing the physical quantity detection device.

### DESCRIPTION OF EMBODIMENTS

The present embodiment will be described below. Note that the present embodiment described below does not unduly limit the scope of the claims. In addition, not all of configurations described in the present embodiment are necessarily essential configuration requirements.

### 1. Physical Quantity Detection Device

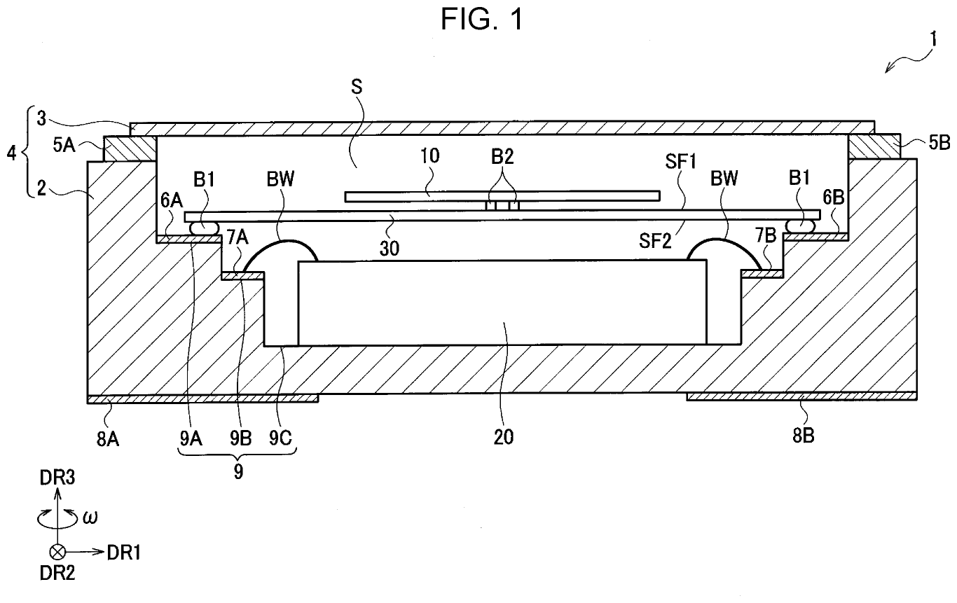

FIG. 1 is a cross-sectional view illustrating an example of a configuration of a physical quantity detection device 1 according to the present embodiment. As illustrated in FIG. 1, the physical quantity detection device 1 according to the present embodiment includes a physical quantity detection element 10, a support substrate 30 that supports the physical quantity detection element 10, and a circuit device 20. The physical quantity detection device 1 may include a package 4 that accommodates the physical quantity detection element 10, the support substrate 30, and the circuit device 20. The physical quantity detection device 1 is not limited to the configuration illustrated in FIG. 1, and various modifications such as omitting some of the constituent elements or adding other constituent elements can be made. In the present embodiment, as illustrated in FIG. 1, directions orthogonal to each other are referred to as a direction DR1 and a direction DR2, and a direction orthogonal to the direction DR1 and the direction DR2 is referred to as a direction DR3. The directions DR1, DR2, and DR3 are a first direction, a second direction, and a third direction, respectively. The arrow tip side in each of the directions DR1, DR2, and DR3 is also referred to as a positive side, and the side opposite to the positive side in each of the directions DR1, DR2, and DR3 is also referred to as a negative side. FIG. 1 is a side view of the physical quantity detection device 1 as viewed in the direction DR2.

The physical quantity detection element 10 is an element for detecting a physical quantity, and can also be referred to as a physical quantity transducer or a vibration element, for example. The physical quantity detection element includes, for example, a vibrator element, and detects a physical quantity using a vibration of the vibrator element. For example, when the physical quantity detection element is a gyro sensor element, an angular velocity is detected as the physical quantity. An example of the gyro sensor element is a sensor element having a piezoelectric vibrator element formed of a thin plate made of a piezoelectric material such as quartz crystal. Specifically, the gyro sensor element is a sensor element having a vibrator element having a double T shape, a tuning fork shape, an H shape, or the like and formed of a quartz crystal substrate such as a Z-cut quartz crystal substrate. Alternatively, a micro-electro-mechanical system (MEMS) sensor element may be used as the gyro sensor element. Further, the physical quantity detected by the physical quantity detection element may be a physical quantity other than the angular velocity, for example, an angular acceleration, an angle, an acceleration, a speed, a movement distance, a pressure, or the like.

The package 4 has a base 2 and a lid 3. Specifically, the package 4 includes the base 2 having a recess 9 opened upward, and the lid 3 bonded to an upper surface of the base 2 so as to form an accommodation space S between the lid 3 and the base 2. The base 2 is coupled to the lid 3 by, for example, bonding members 5A and 5B. For example, the base 2 may be made of ceramic such as alumina, and the lid 3 may be made of a metal material such as Kovar. However, the materials of the base 2 and the lid 3 are not limited thereto.

Inside the package 4, the accommodation space S is formed by an opening portion of the base 2, and the physical quantity detection element 10, the support substrate 30, and the circuit device 20 are accommodated in the accommodation space S. The accommodation space S, which is an internal space, is airtight and is in a reduced pressure state, preferably a state closer to vacuum. Thus, the viscous resistance is reduced, and the vibration characteristics of the physical quantity detection element 10 are improved. However, the atmosphere in the accommodation space S is not particularly limited, and the accommodation space S may be, for example, in an atmospheric pressure state or a pressurized state. The package 4 may include at least the base 2, and may not include the lid 3.

The recess 9 of the base 2 includes a plurality of recesses. For example, the recess 9 includes a recess 9A that is open to the upper surface of the base 2, a recess 9B that is open to a bottom surface of the recess 9A and is narrower than the recess 9A, and a recess 9C that is open to a bottom surface of the recess 9B and is narrower than the recess 9B. The support substrate 30 is fixed to the bottom surface of the recess 9A in a state where the support substrate 30 supports the physical quantity detection element 10. The bottom surface of the recess 9A is a step portion. The circuit device 20 is fixed to a bottom surface of the recess 9C.

As illustrated in FIG. 1, in the accommodation space S, the physical quantity detection element 10, the support substrate 30, and the circuit device 20 are disposed to overlap each other in plan view. For example, the physical quantity detection element 10, the support substrate 30, and the circuit device 20 are disposed side by side along the direction DR3. For example, the support substrate 30 has a surface SF1 which is a first surface and a surface SF2 which is a second surface as main surfaces of the support substrate 30. The physical quantity detection element 10 is disposed on the surface SF1 side of the support substrate 30. Further, the circuit device 20 is disposed on the surface SF2 side of the support substrate 30.

The arrangement of the physical quantity detection element 10, the support substrate 30, and the circuit device 20 is not limited to the arrangement illustrated in FIG. 1. For example, although the support substrate 30 is disposed between the physical quantity detection element 10 and the circuit device 20 in FIG. 1, the physical quantity detection element 10 may be disposed between the support substrate 30 and the circuit device 20. Further, although the physical quantity detection element 10, the support substrate 30, and the circuit device 20 are disposed in this order from the upper surface side of the package 4 in FIG. 1, the circuit device 20, the support substrate 30, and the physical quantity detection element 10 may be disposed in this order from the upper surface side of the package 4.

In addition, as illustrated in FIG. 1, a plurality of internal terminals 6A and 6B are disposed on the step portion of the bottom surface of the recess 9A of the base 2. In addition, a plurality of internal terminals 7A and 7B are disposed on a step portion of the bottom surface of the recess 9B of the base 2. A plurality of external terminals 8A and 8B are disposed on a lower surface of the base 2. The internal terminals 6A and 6B, the internal terminals 7A and 7B, and the external terminals 8A and 8B are electrically coupled to each other via internal wiring (not illustrated). The internal terminals 6A and 6B are electrically coupled to the physical quantity detection element 10 via conductive bonding members B1 and B2 and the support substrate 30. The internal terminals 7A and 7B are electrically coupled to the circuit device 20 via bonding wires BW.

The conductive bonding members B1 and B2 have both conductivity and bonding properties. The conductive bonding members B1 and B2 are not particularly limited, and a conductive adhesive in which a conductive filler such as a silver filler is dispersed in a polyimide-based, epoxy-based, silicone-based, or acryl-based adhesive, various metallic bumps such as a gold bump, a silver bump, a copper bump, or a solder bump, and the like can be used as the conductive bonding members B1 and B2.

For example, in the present embodiment, a conductive adhesive is used as the bonding members B1 between the support substrate 30 and the base 2 of the package 4. Specifically, a thermosetting adhesive is used as the bonding members B1. In the present embodiment, metallic bumps are used as the bonding members B2 between the support substrate 30 and the physical quantity detection element 10. When a conductive adhesive is used as the bonding members B1 for bonding the support substrate 30 and the base 2 made of different materials, thermal stress caused by the difference in thermal expansion coefficient between the support substrate 30 and the base 2 can be absorbed and reduced by the bonding members B1. On the other hand, since the support substrate 30 and the physical quantity detection element 10 are bonded to each other by the plurality of bonding members B2 disposed in a relatively narrow region, the use of the metallic bumps as the bonding members B2 makes it possible to suppress the wetting and spreading of the conductive adhesive and to effectively suppress the contact between the bonding members B2.

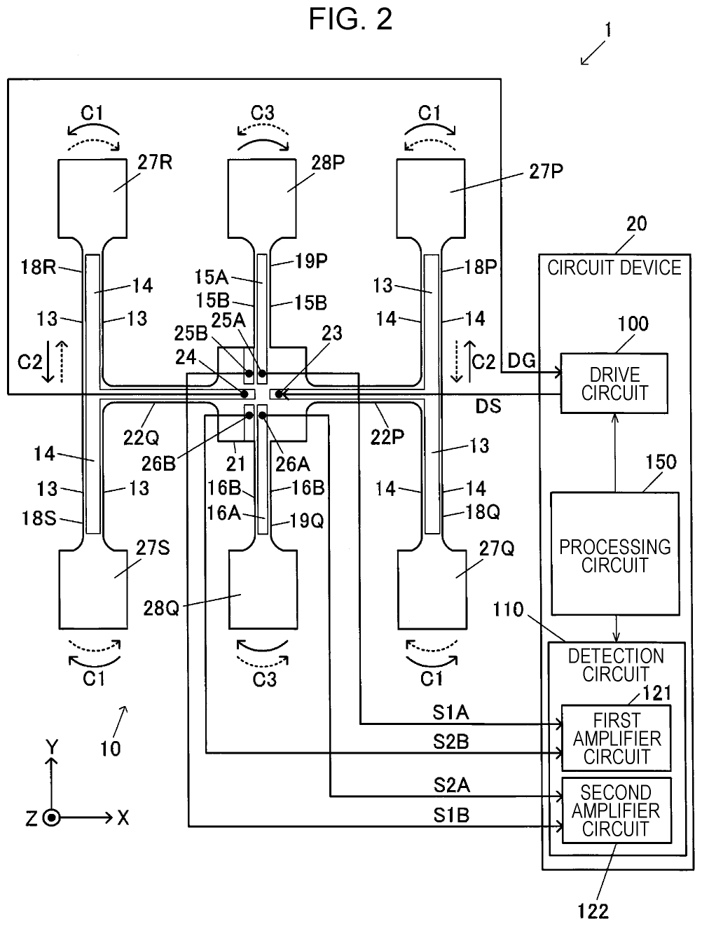

FIG. 2 is a diagram for explaining an example of operation of the physical quantity detection element 10. A case where the physical quantity detection element 10 is a gyro sensor element, specifically, a double T-shaped gyro sensor element will be mainly described below as an example. However, as described above, the physical quantity detection element 10 may be a gyro sensor element other than the double T-shaped gyro sensor or may be a physical quantity detection element other than the gyro sensor element.

For example, when a Z axis is a thickness direction of the physical quantity detection element 10, the physical quantity detection element 10 which is a gyro sensor element detects an angular velocity ω around the Z axis. An X axis and a Y axis are coordinate axes orthogonal to the Z axis, and the X axis and the Y axis are orthogonal to each other. For example, by arranging the physical quantity detection element 10 such that the Z axis in FIG. 2 is along the direction DR3 in FIG. 1, it is possible to detect the angular velocity ω with the axis along the direction DR3 as a detection axis.

As illustrated in FIG. 2, the physical quantity detection device 1 includes the physical quantity detection element 10 and the circuit device 20. The circuit device 20 is, for example, an integrated circuit device that is referred to as an integrated circuit (IC). For example, the circuit device 20 is an IC manufactured by a semiconductor process, and is a semiconductor chip in which a circuit element is formed on a semiconductor substrate. The circuit device 20 includes a drive circuit 100, a detection circuit 110, and a processing circuit 150. Note that one or more of these circuits may not be provided.

The physical quantity detection element 10 includes drive arms 18P, 180, 18R, and 18S, detection arms 19P and 19Q, a base portion 21, and coupling arms 22P and 22Q. The detection arms 19P and 190 extend in a +Y axis direction and a −Y axis direction with respect to the rectangular base portion 21, respectively. In addition, the coupling arms 22P and 220 extend in an +X axis direction and an −X axis direction with respect to the base portion 21, respectively. The drive arms 18P and 180 extend from a tip end portion of the coupling arm 22P in the +Y axis direction and the −Y axis direction with respect to the coupling arm 22P, respectively, and the drive arms 18R and 18S extend from a tip end portion of the coupling arm 220 in the +Y axis direction and the −Y axis direction with respect to the coupling arm 220, respectively.

The physical quantity detection element 10 includes weight portions 27P, 270, 27R, 27S, 28P, and 28Q. These weight portions are also referred to as hammer head portions. The weight portions 27P and 270 are disposed on the tip end sides of the drive arms 18P and 18Q, respectively, and the weight portions 27R and 27S are disposed on the tip end sides of the drive arms 18R and 18S, respectively. Further, the weight portions 28P and 280 are disposed on the tip end sides of the detection arms 19P and 190, respectively. The weight portions 27P, 270, 27R, and 27S disposed at the drive arms 18P, 180, 18R, and 18S are balance adjusting portions and are used for balance adjustment on a vibration of the physical quantity detection element 10. For example, the balance adjustment is performed on the vibration of the physical quantity detection element 10 by performing trimming in which metals of the weight portions 27P, 270, 27R, and 27S are cut by a laser beam during the manufacture of the physical quantity detection device 1.

The vibrator element of the physical quantity detection element 10 can be formed of, for example, a piezoelectric material such as quartz crystal, lithium tantalate, or lithium niobate. Among these, quartz crystal is preferably used as the constituent material of the vibrator element. The X axis, the Y axis, and the Z axis are also referred to as an electric axis, a mechanical axis, and an optical axis of the quartz crystal substrate, respectively. The quartz crystal substrate is formed of a Z-cut quartz crystal plate or the like having a thickness in the Z axis direction.

A drive electrode 13 is formed on upper surfaces and lower surfaces of the drive arms 18P and 180, and a drive electrode 14 is formed on right side surfaces and left side surfaces of the drive arms 18P and 18Q. A drive electrode 14 is formed on upper surfaces and lower surfaces of the drive arms 18R and 18S, and a drive electrode 13 is formed on right side surfaces and left side surfaces of the drive arms 18R and 18S. A drive signal DS from the drive circuit 100 is supplied to the drive electrodes 13, and a feedback signal DG from the drive electrodes 14 is input to the drive circuit 100.

A detection electrode 15A is formed on upper and lower surfaces of the detection arm 19P, and a detection electrode 15B is formed on right and left side surfaces of the detection arm 19P. A detection electrode 16A is formed on upper and lower surfaces of the detection arm 190, and a detection electrode 16B is formed on right and left side surfaces of the detection arms 190. The detection electrodes 15A, 15B, 16A, and 16B are a first detection electrode, a second detection electrode, a third detection electrode, and a fourth detection electrode, respectively.

Then, signals S1A, S1B, S2A, and S2B which are detection signals from the detection electrodes 15A, 15B, 16A, and 16B are input to the detection circuit 110. Specifically, the detection circuit 110 includes a first amplifier circuit 121 and a second amplifier circuit 122. The first amplifier circuit 121 and the second amplifier circuit 122 are, for example, charge/voltage conversion circuits (Q/V conversion circuits), and are also referred to as charge amplifiers. The detection signal S1A from the detection electrode 15A formed on the upper and lower surfaces of the detection arm 19P and the detection signal S2B from the detection electrode 16B formed on the right and left side surfaces of the detection arm 190 are input to the first amplifier circuit 121. The detection signal S2A from the detection electrode 16A formed on the upper and lower surfaces of the detection arm 190 and the detection signal S1B from the detection electrode 15B formed on the right and left side surfaces of the detection arm 19P are input to the second amplifier circuit 122. An output signal of the first amplifier circuit 121 and an output signal of the second amplifier circuit 122 are differentially amplified by a differential amplifier circuit. For example, the signals S1A and S2B are detection signals having an identical phase as described later. In addition, the signals S2A and S1B are detection signals having an identical phase, and are detection signals that have the phase different from that of the signals S1A and S2B by, for example, 180 degrees, and have a polarity different from that of the signals SIA and S2B. With such a configuration, it is possible to implement double wiring capable of substantially doubling the area of the detection electrodes.

Groove portions (not illustrated) for improving an electric field effect between the electrodes are disposed on the upper and lower surfaces of the drive arms 18P, 18Q, 18R, and 18S and the upper and lower surfaces of the detection arms 19P and 190. By providing the groove portions, a relatively large amount of charge can be generated with a relatively small amount of distortion.

The base portion 21 is provided with drive terminals 23 and 24 and detection terminals 25A, 25B, 26A, and 26B. The drive signal DS from the drive circuit 100 is input to the drive terminal 23, and the feedback signal DG is output from the drive terminal 24 to the drive circuit 100. The detection terminals 25A and 26B output the detection signals S1A and S2B to the first amplifier circuit 121, and the detection terminals 26A and 25B output the detection signals S2A and S1B to the second amplifier circuit 122.

The drive circuit 100 included in the circuit device 20 drives the physical quantity detection element 10. The drive circuit 100 outputs the drive signal DS to the physical quantity detection element 10, thereby driving the vibrator element of the physical quantity detection element 10 so as to vibrate the vibrator element. The drive signal DS is, for example, a rectangular wave signal, but may be a sine wave signal.

The detection circuit 110 detects a physical quantity based on the detection signals S1A, S1B, S2A, and S2B from the physical quantity detection element 10. In FIG. 2, an angular velocity is detected as the physical quantity. Each of the detection signals S1A, S1B, S2A, and S2B is, for example, a detection signal of a physical quantity having a drive frequency of the drive signal DS as a carrier frequency. The detection circuit 110 detects the physical quantity (angular velocity) in the detection signals S1A, S1B, S2A, and S2B by performing synchronous detection of a signal based on the detection signals S1A, S1B, S2A, and S2B using, for example, a synchronization signal, and outputs detection data of the detected physical quantity.

The processing circuit 150 performs processing such as digital signal processing on the detection data from the detection circuit 110. The processing circuit 150 performs the digital signal processing including digital filter processing on the detection data from the detection circuit 110. Then, the detection data after the digital filter processing by the processing circuit 150 is output as, for example, a final detected value of the physical quantity. Note that the signal processing performed by the processing circuit 150 is not limited to the digital filter processing, and the processing circuit 150 can perform various kinds of signal processing such as temperature compensation processing and various kinds of correction processing.

Next, a detailed operation when the physical quantity detection element 10 is a gyro sensor element will be described. When the drive signal DS is applied to the drive electrodes 13 by the drive circuit 100, the drive arms 18P, 18Q, 18R, and 18S perform flexural vibrations as indicated by arrows C1 in FIG. 2 due to an inverse piezoelectric effect. For example, a vibration mode indicated by solid line arrows and a vibration mode indicated by dotted line arrows are repeated at a predetermined frequency. That is, the flexural vibrations are performed, in which the tip ends of the drive arms 18P and 18R repeatedly approach and separate from each other and the tip ends of the drive arms 180 and 18S repeatedly approach and separate from each other. In this case, since the drive arms 18P and 18Q vibrate in line symmetry with respect to the X axis passing through the position of the center of gravity of the base portion 21, and the drive arms 18R and 18S vibrate in line symmetry with respect to the X axis passing through the position of the center of gravity of the base portion 21, the base portion 21, the coupling arms 22P and 220, and the detection arms 19P and 190 hardly vibrate.

In this state, when an angular velocity is applied to the physical quantity detection element 10 with the Z axis as a rotational axis, the drive arms 18P, 18Q, 18R, and 18S vibrate as indicated by arrows C2 due to Coriolis force. That is, the Coriolis force in directions indicated by the arrows C2 orthogonal to directions indicated by the arrows C1 and the Z axis direction acts on the drive arms 18P, 18Q, 18R, and 18S, thereby generating vibration components in the directions indicated by the arrows C2. The vibrations in the directions indicated by the arrows C2 are transmitted to the base portion 21 via the coupling arms 22P and 220, whereby the detection arms 19P and 190 perform flexural vibrations in directions indicated by arrows C3. Charge signals generated by a piezoelectric effect due to the flexural vibrations of the detection arms 19P and 19Q are input to the detection circuit 110 as the detection signals S1A, S1B, S2A, and S2B, and the detection circuit 110 detects the angular velocity around the Z axis.

For example, when the angular velocity of the physical quantity detection element 10 around the Z axis is ω, the mass of the physical quantity detection element 10 is m, and the vibration speed of the physical quantity detection element 10 is v, the Coriolis force is expressed as Fc=2m·v·ω. Therefore, when the detection circuit 110 detects a desired signal which is a signal corresponding to the Coriolis force, the angular velocity ω around the Z axis can be obtained.

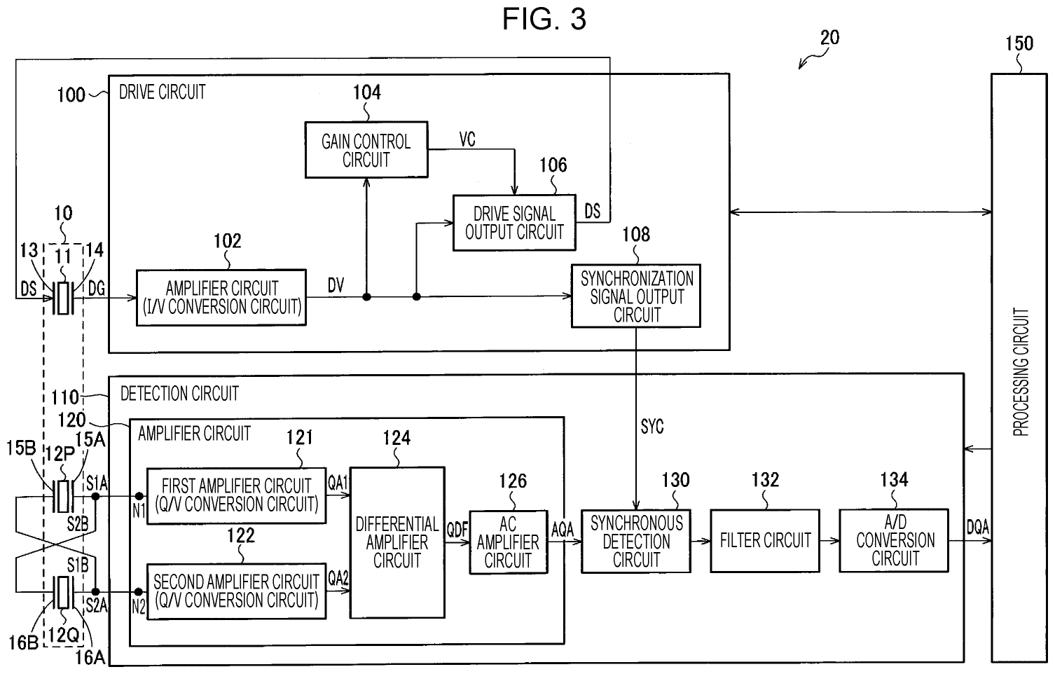

FIG. 3 illustrates an example of a detailed configuration of the circuit device 20. The circuit device 20 is not limited to the configuration illustrated in FIG. 3, and various modifications such as omitting some of constituent elements or adding other constituent elements can be made. Coupling in the present embodiment is electrical coupling. The electrical coupling is coupling in which an electrical signal can be transmitted, and is coupling in which information can be transmitted by an electrical signal. The electrical coupling may be coupling via a passive element or the like.

The physical quantity detection element 10 which is a sensor element includes a vibrator element 11 for driving, vibrator elements 12P and 120 for detection, the drive electrodes 13 and 14, and the detection electrodes 15A, 15B, 16A, and 16B. The vibrator element 11 for driving corresponds to the drive arms 18P, 18Q, 18R, and 18S illustrated in FIG. 2. The vibrator element 12P for detection corresponds to the detection arm 19P illustrated in FIG. 2, and the vibrator element 120 for detection corresponds to the detection arm 19Q. The vibrator elements 11, 12P, and 12Q are, for example, piezoelectric vibrator elements formed of thin plates of a piezoelectric material such as quartz crystal.

The drive signal DS from the drive circuit 100 is supplied to the drive electrodes 13, and thus the vibrator element 11 for driving vibrates. Then, the feedback signal DG generated by the vibration of the vibrator element 11 is input from the drive electrodes 14 to the drive circuit 100. Further, the vibrator elements 12P and 120 for detection vibrate due to the vibration of the vibrator element 11 for driving. Then, charges generated in the detection electrodes 15A and 16B by the vibrations of the vibrator elements 12P and 120 are input to the first amplifier circuit 121 of the detection circuit 110 as the first detection signal S1A and the fourth detection signal S2B (a sum signal of S1A and S2B). In addition, charges generated in the detection electrodes 16A and 15B by the vibrations of the vibrator elements 12P and 120 are input to the second amplifier circuit 122 of the detection circuit 110 as the third detection signal S2A and the second detection signal S1B (a sum signal of S2A and S1B). The circuit device 20 detects the physical quantity such as the angular velocity based on these detection signals.

The drive circuit 100 includes an amplifier circuit 102, a gain control circuit 104, a drive signal output circuit 106, and a synchronization signal output circuit 108.

The amplifier circuit 102 amplifies the feedback signal DG from the physical quantity detection element 10. For example, the amplifier circuit 102 which is an I/V conversion circuit converts the feedback signal DG of an electrical current from the physical quantity detection element 10 into a voltage signal DV and outputs the voltage signal DV.

The gain control circuit 104 outputs a control voltage VC to the drive signal output circuit 106 to control the amplitude of the drive signal DS. For example, the gain control circuit 104 which is an AGC circuit variably and automatically adjusts a gain such that the amplitude of the feedback signal DG from the physical quantity detection element 10 becomes constant in order to keep the sensitivity of the sensor constant. The gain control circuit 104 includes a full-wave rectifier circuit that performs full-wave rectification of the alternating-current signal DV output from the amplifier circuit 102, and an integration circuit that performs integration processing on the signal from the full-wave rectifier circuit. Then, the gain control circuit 104 outputs the control voltage VC obtained by the integration processing to the drive signal output circuit 106.

The drive signal output circuit 106 outputs the drive signal DS based on the signal DV after the amplification by the amplifier circuit 102. The drive signal output circuit 106 outputs, for example, a rectangular wave drive signal DS such that the control voltage VC from the gain control circuit 104 becomes a high-level voltage which is a voltage on the high electrical potential side. For example, the drive signal output circuit 106 may output a sine wave drive signal DS.

The synchronization signal output circuit 108 outputs a synchronization signal SYC. The synchronization signal SYC is a signal generated based on the drive signal DS. Specifically, the synchronization signal SYC corresponds to the drive signal DS, and is, for example, a clock signal having the same frequency as that of the drive signal DS.

The detection circuit 110 includes an amplifier circuit 120, a synchronous detection circuit 130, a filter circuit 132, and an A/D conversion circuit 134. The amplifier circuit 120 includes the first amplifier circuit 121, the second amplifier circuit 122, the differential amplifier circuit 124, and an AC amplifier circuit 126. In the amplifier circuit 120, the first detection signal S1A and the fourth detection signal S2B are input to a first input node N1, and the third detection signal S2A and the second detection signal S1B are input to a second input node N2.

The first amplifier circuit 121 converts the sum signal of S1A and S2B which are the charge signals from the physical quantity detection element 10 into a voltage signal. The second amplifier circuit 122 converts the sum signal of S2A and S1B which are the charge signals from the physical quantity detection element 10 into a voltage signal. The first amplifier circuit 121 and the second amplifier circuit 122 are continuous charge-voltage conversion circuits having a feedback resistor.

The differential amplifier circuit 124 differentially amplifies the signals QA1 and QA2 from the first amplifier circuit 121 and the second amplifier circuit 122. Since physical quantity signals included in the signals QA1 and QA2 are differential signals, the differential amplifier circuit 124 performs differential amplification to amplify the signals. The AC amplifier circuit 126 amplifies an output signal QDF of the differential amplifier circuit 124 and outputs the amplified signal as an output signal AQA of the amplifier circuit 120. The AC amplifier circuit 126 performs, for example, gain adjustment on the signal. Although an input of the first amplifier circuit 121 is coupled to the first input node N1 and an input of the second amplifier circuit 122 is coupled to the second input node N2 in the present embodiment, an input of the differential amplifier circuit 124 may be coupled to the first input node N1 and the second input node N2. That is, the charge signals from the physical quantity detection element 10 may be input to the differential amplifier circuit 124 without passing through the first amplifier circuit 121 and the second amplifier circuit 122.

The synchronous detection circuit 130 performs synchronous detection on the output signal AQA of the amplifier circuit 120 based on the synchronization signal SYC. This synchronous detection makes it possible to extract a physical quantity signal, which is a desired signal included in the output signal AQA, and detect the physical quantity.

The filter circuit 132 performs filter processing such as low-pass filter processing on the output signal of the synchronous detection circuit 130. The filter circuit 132 functions as a pre-filter of the A/D conversion circuit 134 in the subsequent stage. The filter circuit 132 also functions as a circuit that attenuates an unnecessary signal that has not been removed by the synchronous detection. The A/D conversion circuit 134 performs A/D conversion on the analog output signal from the filter circuit 132 and outputs digital detection data DOA.

The processing circuit 150 performs various kinds of digital signal processing on the detection data DQA of the physical quantity from the detection circuit 110. The processing circuit 150 performs temperature correction calculation based on the detection data DQA and temperature detection data. In addition, the processing circuit 150 performs temperature compensation processing on the detection data DOA based on a temperature correction value obtained by the temperature correction calculation. Then, the processing circuit 150 performs digital filter processing such as low-pass filter processing and notch filter processing on the detection data after the temperature compensation processing.

As described above, in the present embodiment, the charge signals from the detection electrodes 15B and 16B in addition to the detection electrodes 15A and 16A are input to the detection circuit 110 and amplified by the first amplifier circuit 121 and the second amplifier circuit 122. In this way, when the same physical quantity such as the angular velocity is detected, the amount of charge input to the detection circuit 110 increases, and thus it is possible to improve the sensitivity for detection of the physical quantity. As a result, the S/N ratio in the detection of the physical quantity is improved, and noise reduction can be implemented.

### 2. Amplifier Circuit

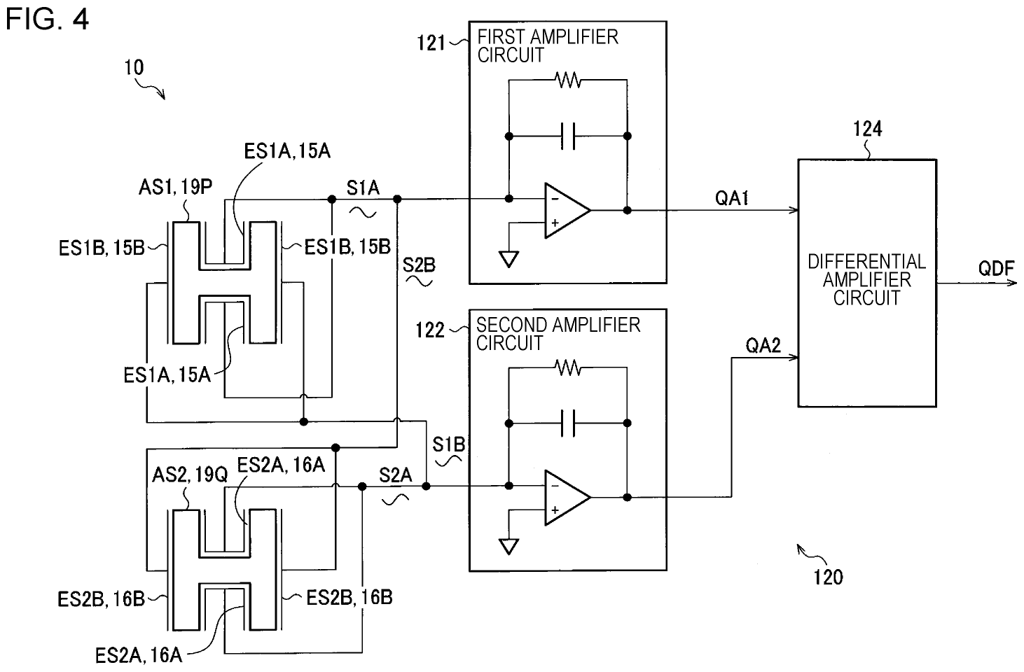

Next, the amplifier circuit 120 of the detection circuit 110 according to the present embodiment will be described in detail. As illustrated in FIG. 4, the amplifier circuit 120 includes the first amplifier circuit 121, the second amplifier circuit 122, and the differential amplifier circuit 124. The physical quantity detection element 10 includes a first detection arm AS1 and a second detection arm AS2. The first and second detection arms AS1 and AS2 correspond to the detection arms 19P and 19Q illustrated in FIG. 2, respectively.

The first detection arm AS1 includes a first detection electrode ES1A and a second detection electrode ES1B. The second detection arm AS2 includes a third detection electrode ES2A and a fourth detection electrode ES2B. The first detection electrode ES1A and the second detection electrode ES1B correspond to the detection electrodes 15A and 15B illustrated in FIG. 2, respectively. The third detection electrode ES2A and the fourth detection electrode ES2B correspond to the detection electrodes 16A and 16B illustrated in FIG. 2, respectively. Although not particularly limited, the first detection electrode ES1A is formed on, for example, upper and lower surfaces of the first detection arm AS1 and the third detection electrode ES2A is formed on, for example, upper and lower surfaces of the second detection arm AS2. Further, the second detection electrode ES1B is formed on, for example, right and left side surfaces of the first detection arm AS1 and the fourth detection electrode ES2B is formed on, for example, right and left side surfaces of the second detection arm AS2. However, the surfaces on which the detection electrodes are formed may be opposite to the surfaces described above.

The first detection signal S1A from the first detection electrode ES1A of the first detection arm AS1 and the fourth detection signal S2B from the fourth detection electrode ES2B of the second detection arm AS2 are input to the first amplifier circuit 121. The third detection signal S2A from the third detection electrode ES2A of the second detection arm AS2 and the second detection signal S1B from the second detection electrode ES1B of the first detection arm AS1 are input to the second amplifier circuit 122.

In the present embodiment, in the description of S1A, S1B, S2A, and S2B, “1” and “2” correspond to “first” and “second” of the first detection arm AS1 and the second detection arm AS2, respectively, and “A” and “B” correspond to the upper and lower surfaces of the detection arms and the right and the left side surfaces of the detection arms, respectively.

Each of the first amplifier circuit 121 and the second amplifier circuit 122 includes an operational amplifier, a resistor for feedback, and a capacitor for feedback. For example, a non-inverting input terminal of the operational amplifier is set to analog GND, and a detection signal from the physical quantity detection element 10 is input to an inverting input terminal of the operational amplifier. An output of the operational amplifier is fed back to a node of the inverting input terminal, which is the input of the operational amplifier, via the resistor and the capacitor. According to this configuration, each of the amplifier circuits operates as a Q/V conversion circuit that converts a detection signal, which is a charge signal, into a voltage signal. The signals QA1 and QA2 from the first amplifier circuit 121 and the second amplifier circuit 122 are input to the differential amplifier circuit 124 and differentially amplified by the differential amplifier circuit 124, and the differentially amplified signal QDF is output from the differential amplifier circuit 124.

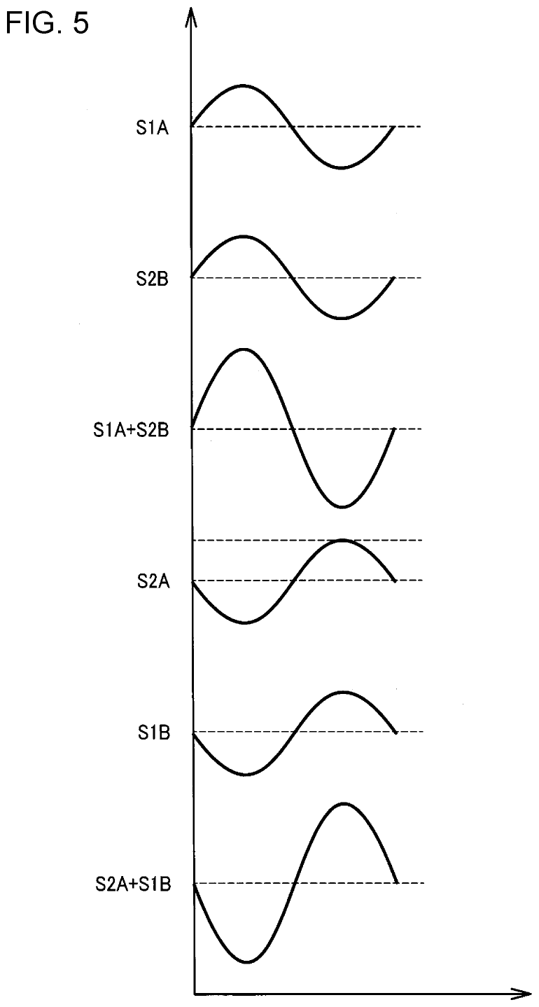

FIG. 5 is a signal waveform diagram for explaining operation of the amplifier circuit 120 illustrated in FIG. 4. As illustrated in FIG. 5, the signals S1A and S2B have the identical phase. For this reason, the signal S1A+S2B, which is the sum signal (summed signal) of SIA and S2B, has about twice the amplitudes of the signals SIA and S2B. The sum signal S1A+S2B is input to the first amplifier circuit 121.

As illustrated in FIG. 5, the signals S2A and S1B have the identical phase. For this reason, the signal S2A+S1B, which is the sum signal (summed signal) of S2A and S1B, has about twice the amplitudes of the signals S2A and S1B. The sum signal S2A+S1B is input to the second amplifier circuit 122.

The phase of the sum signal S1A+S2B is different by 180 degrees from the phase of the sum signal S2A+S1B, and has an electrical polarity opposite to that of the sum signal S2A+S1B. For example, when the sum signal S1A+S2B has a first polarity that is one of a positive polarity and a negative polarity, the sum signal S2A+S1B has a second polarity that is the other of the positive polarity and the negative polarity.

For example, in the first detection arm AS1, when a positive charge is generated in the first detection electrode ES1A, a negative charge is generated in the second detection electrode ES1B, and when a negative charge is generated in the first detection electrode ES1A, a positive charge is generated in the second detection electrode ES1B. Therefore, the first detection signal SIA from the first detection electrode ES1A and the second detection signal S1B from the second detection electrode ES1B have opposite phases.

Similarly, in the second detection arm AS2, when one of a positive charge and a negative charge is generated in the third detection electrode ES2A, the other of the positive charge and the negative charge is generated in the fourth detection electrode ES2B. Therefore, the third detection signal S2A from the third detection electrodes ES2A and the fourth detection signal S2B from the fourth detection electrodes ES2B have opposite phases.

As indicated by the solid-line and dotted-line arrows C3 in FIG. 2, the Coriolis force causes the second detection arm AS2 (19Q) to bend in the −X axis direction when the first detection arm AS1 (19P) bends in the +X axis direction, and causes the second detection arm AS2 to bend in the +X axis direction when the first detection arm AS1 bends in the −X axis direction. Therefore, when one of a positive charge and a negative charge is generated in the first detection electrode ESIA of the first detection arm AS1, the other of the positive charge and the negative charge is generated in the third detection electrode ES2A of the second detection arm AS2. Therefore, the first detection signal S1A from the first detection electrode ES1A and the third detection signal S2A from the third detection electrode ES2A have opposite phases. Similarly, the second detection signal S1B from the second detection electrode ES1B and the fourth detection signal S2B from the fourth detection electrode ES2B have opposite phases.

Therefore, as illustrated in FIG. 5, the signals S1A and S2B have the identical phase, the signals S2A and S1B have the identical phase, and the sum signal S1A+S2B and the sum signal S2A+S1B have opposite phases.

In this way, in the amplifier circuit 120 illustrated in FIG. 4, the signal S2B which is the charge signal from the fourth detection electrode ES2B is added to the signal S1A which is the charge signal from the first detection electrode ES1A, and the sum signal S1A+S2B is input to the first amplifier circuit 121 as a double-amplitude charge signal. In addition, the signal S1B which is the charge signal from the second detection electrode ES1B is added to the signal S2A which is the charge signal from the third detection electrode ES2A, and the sum signal S2A+S1B is input to the second amplifier circuit 122 as a double-amplitude charge signal. Therefore, the area of the detection electrodes can be substantially doubled, and the sensitivity for detection of the physical quantity of the physical quantity detection device 1 can be improved. In the present embodiment, the method of substantially doubling the area of the detection electrodes is referred to as “double wiring” for convenience.

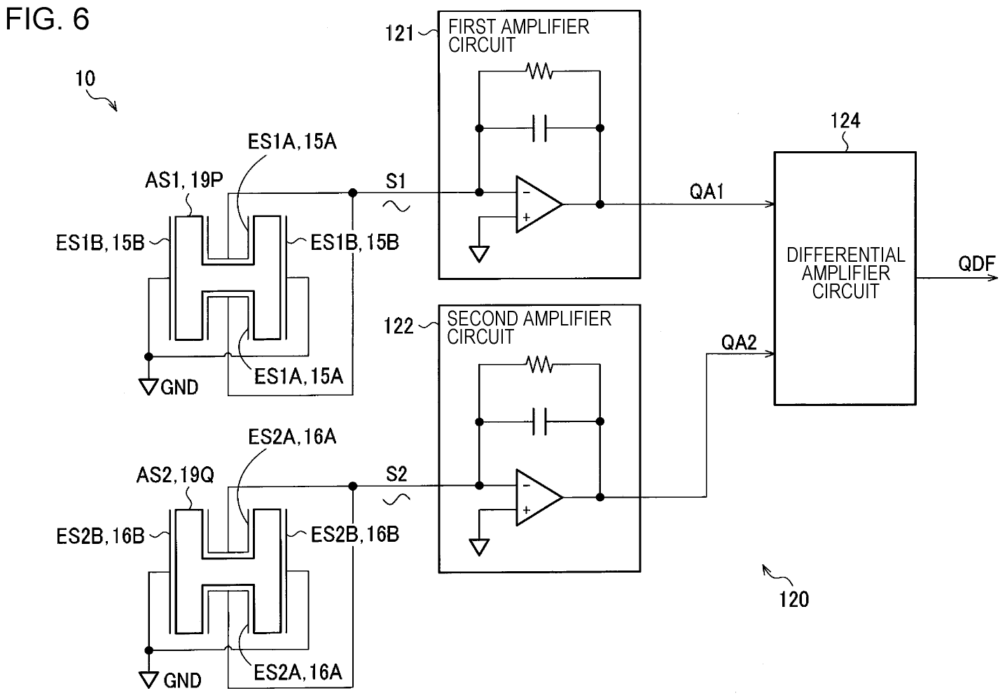

For example, FIG. 6 is an explanatory diagram of an amplifier circuit 120 according to a comparative example. The comparative example illustrated in FIG. 6 is different from FIG. 4 in that a second detection electrode ES1B of a first detection arm AS1 and a fourth detection electrode ES2B of a second detection arm AS2 are grounded in FIG. 6.

In the configuration in the comparative example illustrated in FIG. 6, charges generated in the second detection electrode ES1B of the first detection arm AS1 and charges generated in the fourth detection electrode ES2B of the second detection arm AS2 are discharged to the ground (GND) without being input to a first amplifier circuit 121 and a second amplifier circuit 122. Therefore, the amplitude of a detection signal cannot be doubled, unlike in FIG. 5, and there is a disadvantage that the sensitivity for detection is lowered as compared with that in the configuration illustrated in FIG. 4. On the other hand, as will be described later, there is a problem in that the configuration illustrated in FIG. 4 cannot implement balance tuning which is balance adjustment on a vibration of the physical quantity detection element 10.

### 3. Balance Tuning and Double Wiring

In the physical quantity detection device 1, the balance of vibrations of the drive arms is poor in the initial state due to a process variation or the like during the manufacture, and an unnecessary vibration occurs in the detection arms at the time of driving the physical quantity detection element 10. Therefore, in balance tuning, while a detection signal generated due to the unnecessary vibration is measured, a metal weight film of each drive arm is trimmed by an energy beam such as a laser beam to adjust a frequency, thereby reducing the unnecessary vibration. In the balance tuning, unnecessary signals generated from two of the detection arms are individually measured for each of the detection arms, and a drive arm to be processed and the amount of the processing on the drive arm are calculated according to the measured values.

However, in the configuration illustrated in FIG. 4, since the unnecessary signals generated from the two detection arms are summed and then input to the amplifier circuit, it is not possible to know from which detection arms the measured unnecessary signals are generated, and there is a problem in that it is not possible to calculate the drive arm to be processed and the amount of the processing on the drive arm.

For example, when the drive arms are vibrated and no angular velocity is generated, the first detection arm AS1 and the second detection arm AS2 should not vibrate ideally, but before the balance tuning, the first detection arm AS1 and the second detection arm AS2 vibrate due to a process variation during the manufacture or the like. For this reason, in the balance tuning, unnecessary signals due to unnecessary vibrations of the first detection arm AS1 and the second detection arm AS2 are measured, and the drive arm to be processed and the amount of the processing on the drive arm are calculated based on the measured values.

In the configuration illustrated in FIG. 6, the unnecessary vibration of the first detection arm AS can be measured based on the output of the first amplifier circuit 121 to which the unnecessary signal from the first detection arm AS1 is input as the detection signal S1. In addition, the unnecessary vibration of the second detection arm AS2 can be measured based on the output of the second amplifier circuit 122 to which the unnecessary signal from the second detection arm AS2 is input as the detection signal S2.

However, in the configuration illustrated in FIG. 4, not only the unnecessary signal due to the unnecessary vibration of the first detection arm AS1 but also the unnecessary signal due to the unnecessary vibration of the second detection arm AS2 are input to the first amplifier circuit 121. In addition, not only the unnecessary signal due to the unnecessary vibration of the second detection arm AS2 but also the unnecessary signal due to the unnecessary vibration of the first detection arm AS1 are input to the second amplifier circuit 122. Therefore, since it is not possible to individually measure the unnecessary signals due to the unnecessary vibrations of the respective first and second detection arm AS1 and AS2, there is a problem in that it is not possible to implement appropriate balance tuning.

Therefore, in the present embodiment, attention is paid to the support substrate 30 interposed between the physical quantity detection element 10 and the circuit device 20 to relay a signal, and a method of forming the coupling configuration as illustrated in FIG. 6 during inspection and forming the coupling configuration as illustrated in FIG. 4 during operation by wiring cutting and wiring coupling on the support substrate 30 is adopted. That is, during the inspection of the physical quantity detection device 1, an unnecessary signal of each of the detection arms can be individually measured, and the balance tuning can be performed. Then, after the balance tuning, the detection of the double wiring which doubles the area of the detection electrodes can be performed by the wiring cutting and the wiring coupling on the support substrate 30 during the operation of the physical quantity detection device 1. The method according to the present embodiment will be described below in detail.

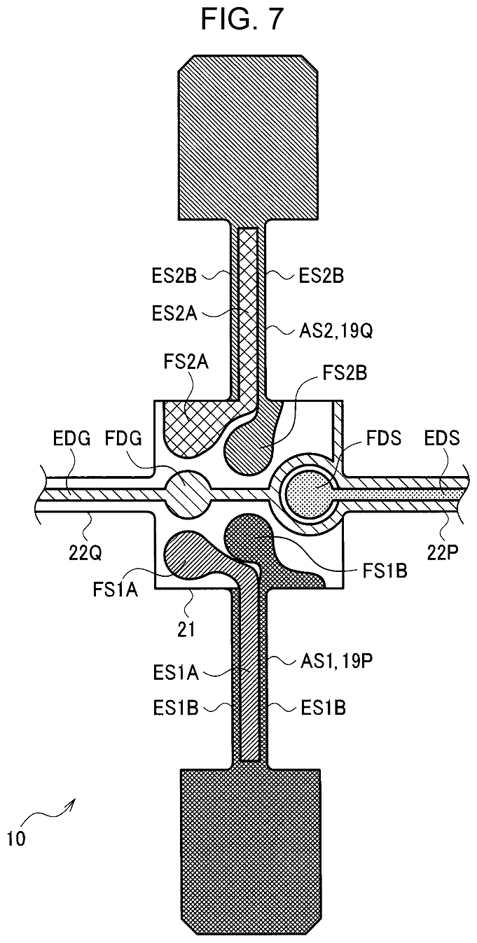

FIG. 7 is a plan view of the physical quantity detection element 10. FIG. 7 is a plan view of the physical quantity detection element 10 as viewed from the lower surface side, and mainly illustrates wiring around the base portion 21.

In FIG. 7, the physical quantity detection element 10 includes the base portion 21, the first detection arm AS1 (19P), and the second detection arm AS2 (19Q). The first detection arm AS1 includes the first detection electrode ES1A and the second detection electrode ES1B, and the second detection arm AS2 includes the third detection electrode ES2A and the fourth detection electrode ES2B. In the base portion 21, a terminal FS1A to which the first detection electrode ES1A is coupled and a terminal FS1B to which the second detection electrode ES1B is coupled are formed. In addition, in the base portion 21, a terminal FS2A to which the third detection electrode ES2A is coupled and a terminal FS2B to which the fourth detection electrode ES2B is coupled are formed. The terminals FS1A and FS1B correspond to the terminals 25A and 25B illustrated in FIG. 2, respectively, and the terminals FS2A and FS2B correspond to the terminals 26A and 26B illustrated in FIG. 2, respectively. In addition, in the base portion 21, terminals FDS and FDG to which drive electrodes EDS and EDG are coupled are also formed.

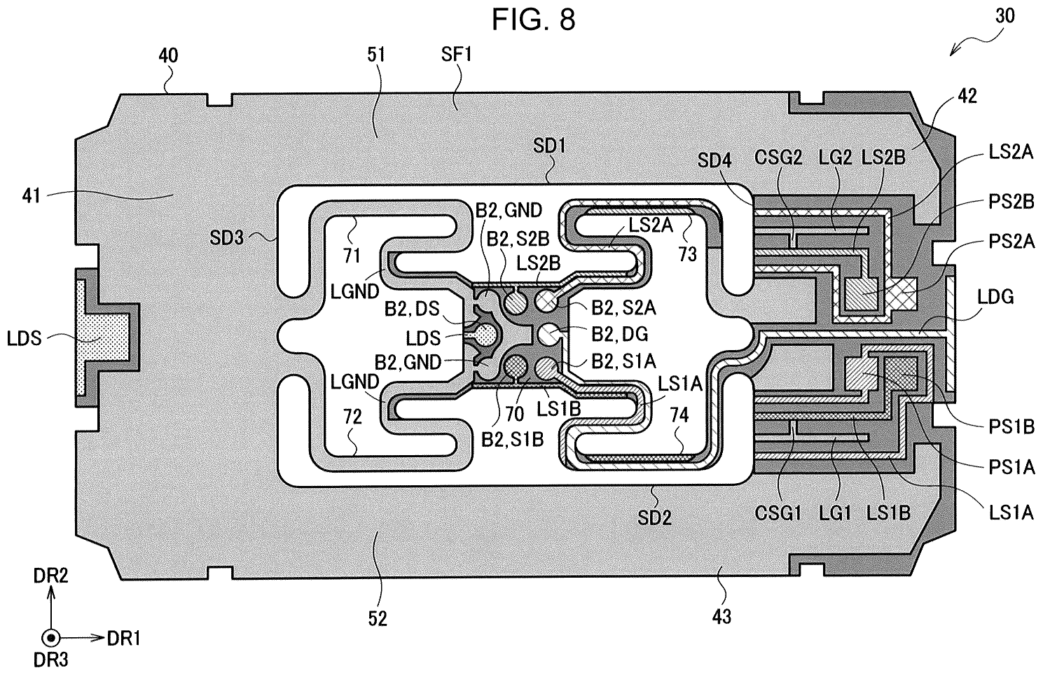

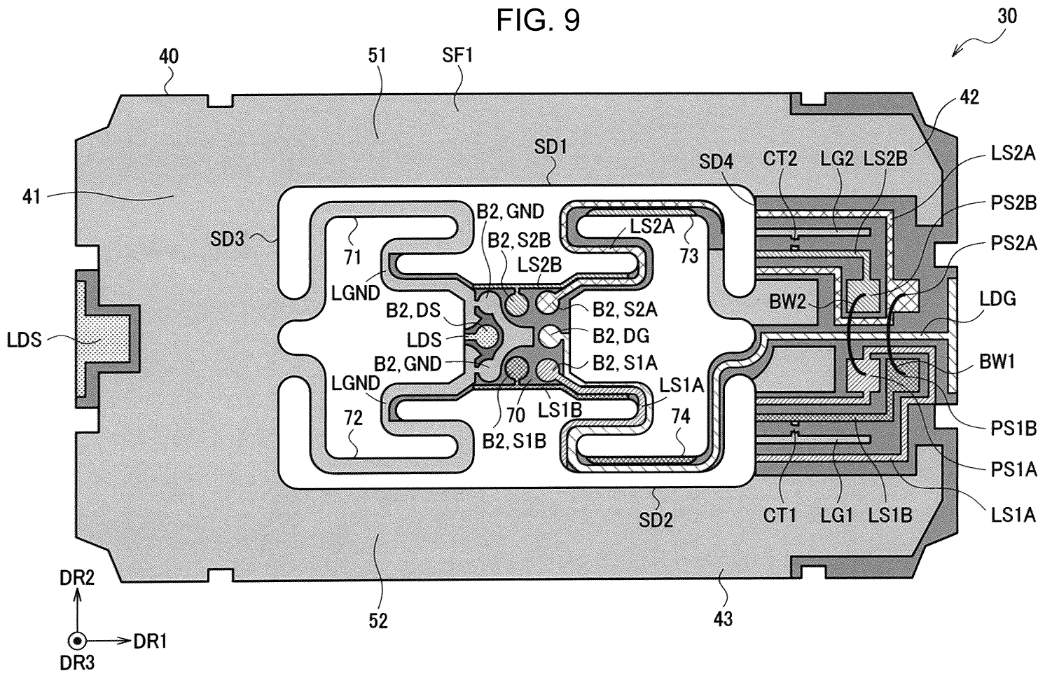

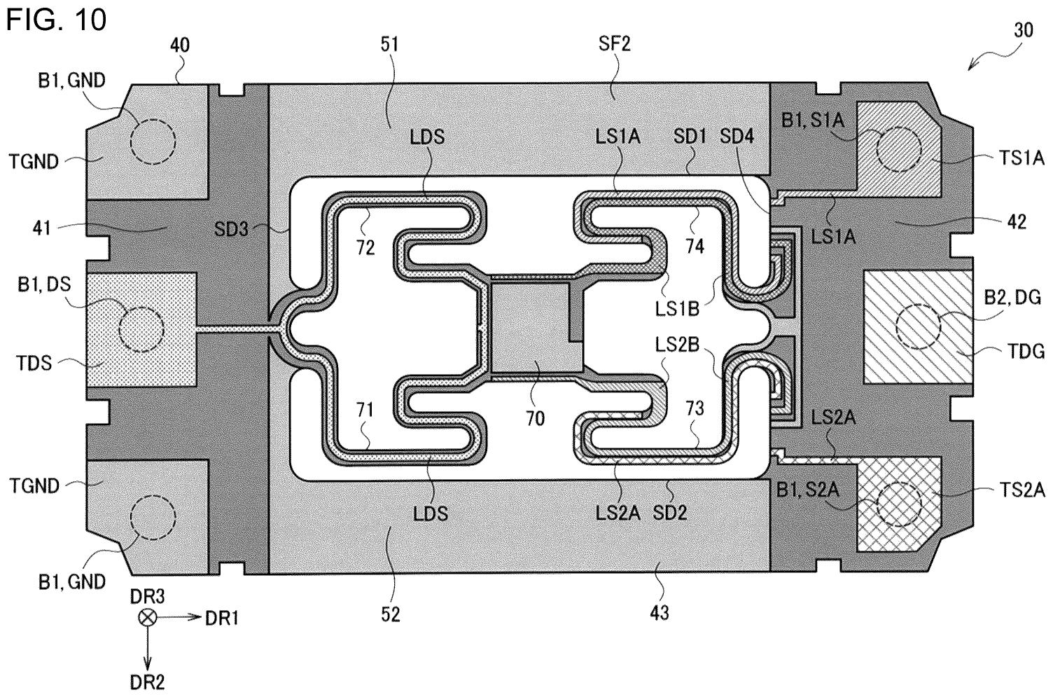

Next, a detailed example of the support substrate 30 will be described. FIGS. 8, 9, and 10 are plan views of the support substrate 30. The support substrate 30 is also referred to as a relay substrate, and is, for example, a plate-shaped substrate having a surface SF1 as a first surface and a surface SF2 as a second surface. FIGS. 8 and 9 are plan views of the support substrate 30 as viewed from the surface SF1 side, and FIG. 10 is a plan view of the support substrate 30 as viewed from the surface SF2 side. As will be described later, FIG. 8 is a plan view illustrating an example of wiring of the support substrate 30 during the inspection of the physical quantity detection device 1, and FIG. 9 is a plan view illustrating an example of wiring of the support substrate 30 during the operation of the physical quantity detection device 1.

In the present embodiment, the surface SF1 is described as an upper surface of the support substrate 30, and the surface SF2 is described as a lower surface of the support substrate 30. In FIGS. 8, 9, and 10, the direction DR1 which is the first direction is, for example, a direction along a long side of the support substrate 30, and the direction DR2 which is the second direction is, for example, a direction along a short side of the support substrate 30. The direction DR3 which is the third direction is a direction orthogonal to the direction DR1 and the direction DR2. The term “orthogonal” includes substantially orthogonal.

As illustrated in FIGS. 8 to 10, the support substrate 30 includes a frame portion 40, an element mounting portion 70, and a plurality of beam portions 71, 72, 73, and 74. The element mounting portion 70 is disposed inside the frame portion 40, and the physical quantity detection element 10 is mounted on the element mounting portion 70. The beam portions 71, 72, 73, and 74 support the element mounting portion 70 inside the frame portion 40. In addition, the support substrate 30 is not limited to the configuration illustrated in FIGS. 8 to 10, and various modifications such as omitting some of the constituent elements or adding other constituent elements can be made. For example, in the following description, the support substrate 30 has the shape of the frame portion 40, but the support substrate 30 may not have the shape of the frame portion 40.

The support substrate 30 is formed of, for example, a quartz crystal substrate. When the support substrate 30 is formed of a quartz crystal substrate, a fluctuation in the resonance frequency of the support substrate 30 due to temperature can be reduced as compared with a case where a support member formed of, for example, a bonded body of a polyimide film and a copper foil is used. Thus, it is possible to suppress the occurrence of an unnecessary vibration in the physical quantity detection element 10 due to a vibration caused by the resonance frequency of the support substrate 30. The support substrate 30 is formed of, for example, a substrate made of the same material as that of the physical quantity detection element 10. For example, when the physical quantity detection element 10 is formed of a quartz crystal substrate, the support substrate 30 is also formed of the same quartz crystal substrate. When the support substrate 30 is formed of a quartz crystal substrate similarly to the physical quantity detection element 10, it is possible to equalize the thermal expansion coefficients of the support substrate 30 and the physical quantity detection element 10. Therefore, thermal stress caused by a difference in thermal expansion coefficient between the support substrate 30 and the physical quantity detection element 10 is not substantially generated between the support substrate 30 and the physical quantity detection element 10, and for example, it is possible to prevent a situation in which the bonding members B2 between the support substrate 30 and the physical quantity detection element 10 are peeled off due to thermal stress. In addition, the physical quantity detection element 10 is less likely to receive stress, and thus it is possible to more effectively suppress degradation and a fluctuation in the vibration characteristics of the physical quantity detection element 10.

For example, the support substrate 30 is formed of a quartz crystal substrate having the same cut angle as that of the physical quantity detection element 10. For example, when the physical quantity detection element 10 is formed of a Z-cut quartz crystal substrate, the support substrate 30 is also formed of a Z-cut quartz crystal substrate. The orientation of the crystal axis of the support substrate 30 matches the orientation of the crystal axis of the substrate of the physical quantity detection element 10. That is, the X, Y, and Z axes match between the support substrate 30 and the physical quantity detection element 10. The quartz crystal has different thermal expansion coefficients in the X axis direction, the Y axis direction, and the Z axis direction. Therefore, by setting the support substrate 30 and the substrate of the physical quantity detection element 10 to have the same cut angle and aligning the directions of the crystal axes, the above-described thermal stress is less likely to occur between the support substrate 30 and the physical quantity detection element 10. Accordingly, it is possible to further suppress the peeling of the bonding members B2, the degradation of the vibration characteristics, and the like caused by the thermal stress.

For example, the support substrate 30 is not limited to the above-described configuration, and may have the same cut angle as that of the substrate of the physical quantity detection element 10, but the orientation of the crystal axis of the support substrate 30 may be different from that of the substrate of the physical quantity detection element 10. The support substrate 30 may be formed of a quartz crystal substrate having a cut angle different from that of the substrate of the physical quantity detection element 10. In addition, the support substrate 30 may not be formed of a quartz crystal substrate. In this case, the constituent material of the support substrate 30 is preferably a material having a smaller difference in thermal expansion coefficient from quartz crystal than the difference in thermal expansion coefficient between quartz crystal and the constituent material of the base 2.

As illustrated in FIGS. 8 to 10, the support substrate 30 according to the present embodiment includes the frame portion 40. The frame portion 40 is a frame-shaped member having an inner region formed so as to surround the element mounting portion 70. For example, the frame portion 40 is a frame-shaped member having a shape in which the element mounting portion 70 is surrounded by a plurality of inner peripheries on the inner side of the frame portion 40. For example, in FIGS. 8 to 10, the element mounting portion 70 is surrounded by four inner peripheries SD1, SD2, SD3, and SD4, but may be surrounded by, for example, three inner peripheries or five or more inner peripheries.

Specifically, the frame portion 40 of the support substrate 30 includes support portions 41 and 42 and coupling portions 51 and 52. The support portion 41 is a first support portion, and the support portion 42 is a second support portion. The coupling portion 51 is a first coupling portion, and the coupling portion 52 is a second coupling portion.

For example, the support portion 41 which is the first support portion is attached to the base 2. The support portion 42 which is the second support portion faces the support portion 41 and is attached to the base 2. For example, as illustrated in FIGS. 8 to 10, the support portion 41 and the support portion 42 face each other in the direction DR1. As illustrated in FIG. 1, the support portions 41 and 42 are bonded and attached to the base 2 by the bonding members B1. To be more specific, the support portions 41 and 42 are bonded and attached to the step portion of the recess 9A of the base 2 by the bonding members B1 which are a conductive adhesive. For example, the bonding by the bonding members B1 is implemented by applying a conductive adhesive, which is a thermosetting adhesive such as a silver paste, to the internal terminals 6A and 6B illustrated in FIG. 1 and bonding the support portions 41 and 42 of the support substrate 30.

The coupling portions 51 and 52 couple the support portion 41 as the first support portion and the support portion 42 as the second support portion. For example, the coupling portion 51 as the first coupling portion couples the support portion 41 and the support portion 42 on the upper side in FIG. 8, and the coupling portion 52 as the second coupling portion couples the support portion 41 and the support portion 42 on the lower side in FIG. 8. A region surrounded by the support portions 41 and 42 and the coupling portions 51 and 52 is the inner region of the frame portion 40, and the element mounting portion 70 is disposed in the inner region. Although the number of coupling portions is two in FIGS. 8 to 10, the number of coupling portions may be one or three or more.

The beam portions 71, 72, 73, and 74 support the element mounting portion 70 in the inner region of the frame portion 40. The beam portions 71, 72, 73, and 74 can also be referred to as spring portions. For example, the beam portions 71 and 72 extend from the support portion 41 of the frame portion 40 in the direction DR1. The beam portions 73 and 74 extend from the support portion 42 of the frame portion 40 in a direction opposite to the direction DR1. FIGS. 8 to 10 illustrate the case where the four beam portions 71, 72, 73, and 74 are provided as the plurality of beam portions, but the present embodiment is not limited thereto, and the number of beam portions may be two, three, or five or more. For example, as the plurality of beam portions, only the beam portions 71 and 73 may be provided or only the beam portions 72 and 74 may be provided.

As illustrated in FIGS. 8 to 10, each of the beam portions 71, 72, 73, and 74 has an S-shaped meandering portion in the middle thereof, and has a shape that is easily elastically deformed in the directions DR1, DR2, and DR3. Since the beam portions 71 to 74 are deformed in the directions DR1, DR2, and DR3, the beam portions 71 to 74 can effectively absorb and relieve stress transmitted from the base 2. For example, since each of the beam portions 71 to 74 can be lengthened by meandering in an S shape, the beam portions 71 to 74 can be flexibly deformed so as to absorb stress and distortion. Similarly, the beam portions 71 to 74 can absorb a mechanical impact such as a drop impact or a vibration impact on the physical quantity detection device 1, and reduce stress, distortion, a mechanical impact, and the like which occurred in the physical quantity detection element 10. However, the shape of each of the beam portions 71 to 74 is not particularly limited, and for example, the meandering portions may be omitted and each of the beam portions 71 to 74 may have a straight shape. Further, at least one of the beam portions 71 to 74 may have a different shape from the others.

The physical quantity detection element 10 is attached to and mounted on the element mounting portion 70 supported by the beam portions 71 to 74. For example, the base portion 21 of the physical quantity detection element 10 illustrated in FIG. 2 is fixed via the conductive bonding members B2 illustrated in FIGS. 8 and 9, and thus the physical quantity detection element 10 is attached to the element mounting portion 70. For example, terminals such as the drive terminals and the detection terminals disposed on the base portion 21 of the physical quantity detection element 10 are bonded to the respective bonding members B2 illustrated in FIG. 3.

That is, the terminal FDS for DS that is coupled to the drive electrode EDS in the base portion 21 of the physical quantity detection element 10 illustrated in FIG. 7 is bonded to the bonding member B2 for DS that is formed in the element mounting portion 70 illustrated in FIGS. 8 and 9. The terminal FDG for DG that is coupled to the drive electrode EDG in the base portion 21 is bonded to the bonding member B2 for DG that is formed in the element mounting portion 70.

In addition, the terminal FS1A for S1A coupled to the first detection electrode ES1A and the terminal FS1B for S1B coupled to the second detection electrode ES1B in the base portion 21 are bonded to the bonding members B2 for S1A and S1B formed in the element mounting portion 70, respectively. In addition, the terminal FS2A for S2A coupled to the third detection electrode ES2A and the terminal FS2B for S2B coupled to the fourth detection electrode ES2B in the base portion 21 are bonded to the bonding members B2 for S2A and S2B formed in the element mounting portion 70, respectively.

In addition, as illustrated in FIGS. 8 to 10, wiring LDS, LDG, LS1A, LS1B, LS2A, LS2B, and LGND for DS, DG, S1A, S1B, S2A, S2B, and GND are disposed on the support substrate 30. In addition, as illustrated in FIG. 10, terminals TDS, TDG, TS1A, TS2A, and TGND for DS, DG, S1A, S2A, and GND are disposed on, for example, the surface SF2 which is the lower surface of the support substrate 30. A metallic film 43 set to GND, which is an electrical potential, is formed on the upper surface and the lower surface of the support substrate 30, and a wiring LGND for GND is formed by the metallic film 43. Note that the GND is the electrical potential of a low electrical potential side power supply and can also be referred to as VSS.

For example, as illustrated in FIGS. 8 and 9, one end of the wiring LDS for DS is coupled to the bonding member B2 for DS, and the other end of the wiring LDS for DS is routed on the support substrate 30 and coupled to the terminal TDS for DS as illustrated in FIG. 10. As illustrated in FIGS. 8 and 9, one end of the wiring LDG for DG is coupled to the bonding member B2 for DG, the other end of the wiring LDG for DG is routed on the support substrate 30 and coupled to the terminal TDG for DG as illustrated in FIG. 10. As illustrated in FIGS. 8 and 9, one end of the first wiring LS1A for S1A and one end of the third wiring LS2A for S2A are coupled to the bonding member B2 for S1A and the bonding member B2 for S2A, respectively, and the other end of the first wiring LS1A for S1A and the other end of the third wiring LS2A for S2A are routed on the support substrate 30 and coupled to the terminal TS1A for S1A and the terminal TS2A for S2A, respectively, as illustrated in FIG. 10. As illustrated in FIGS. 8 and 9, one end of the wiring LGND for GND is coupled to the bonding member B2 for GND, and the other end of the wiring LGND for GND is routed on the support substrate 30 and coupled to the terminal TGND for GND as illustrated in FIG. 10.

Then, the terminals TDS, TDG, TS1A, TS2A, and TGND for DS, DG, S1A, S2A, and GND are coupled to the internal terminals 6A and 6B disposed on the step portion of the recess 9A illustrated in FIG. 1 via the bonding members B1 for DS, DG, S1A, S2A, and GND. As described above, the internal terminals 6A and 6B are coupled to the internal terminals 7A and 7B via internal wiring (not illustrated), and the internal terminals 7A and 7B are coupled to the circuit device 20 via the bonding wires BW. Accordingly, it is possible to transmit the drive signal DS, the feedback signal DG, and the detection signals S1A and S2A between the physical quantity detection element 10 and the circuit device 20 via the support substrate 30. In this way, the support substrate 30 also functions as a relay substrate for relaying the signals. The terminal TGND for GND of the support substrate 30 is coupled to a terminal (pad) for GND of the circuit device 20, and is also coupled to external terminals for GND provided as the external terminals 8A and 8B illustrated in FIG. 1.

As described above, the support substrate 30 according to the present embodiment is used as a relay substrate that relays the signals DS, DG, S1A, and S2A between the physical quantity detection element 10 and the circuit device 20. In the present embodiment, both the improvement of the detection sensitivity by the double wiring described with reference to FIG. 4 and the balance tuning for a vibration of the physical quantity detection element 10 are implemented by using the support substrate 30 which serves as the relay substrate.

For example, in the present embodiment, the second wiring LS1B and the fourth wiring LS2B are coupled to the ground during the inspection of the physical quantity detection device 1. That is, during the inspection, the second wiring LS1B coupled to the second detection electrode ES1B of the first detection arm AS1 is coupled to the ground, and the fourth wiring LS2B coupled to the fourth detection electrode ES2B of the second detection arm AS2 is also coupled to the ground. To be specific, as illustrated in the example of the wiring during the inspection in FIG. 8, the second wiring LS1B is coupled to first ground wiring LG1 via a coupling line CSG1, and thus the second wiring LS1B is coupled to the ground. In addition, the fourth wiring LS2B is coupled to second ground wiring LG2 via a coupling line CSG2, and thus the fourth wiring LS2B is coupled to the ground.

In this way, as illustrated in the example of the configuration in FIG. 6, during the inspection, the second detection electrode ES1B of the first detection arm AS1 is coupled to the ground, and the fourth detection electrode ES2B of the second detection arm AS2 is coupled to the ground. Therefore, during the balance tuning in the inspection, as illustrated in FIG. 6, an unnecessary signal due to an unnecessary vibration of the first detection arm AS1 and an unnecessary signal due to an unnecessary vibration of the second detection arm AS2 can be individually measured. Accordingly, it is possible to calculate a drive arm to be processed and the amount of the processing based on a measured value based on an output of the first amplifier circuit 121 and a measured value based on an output of the second amplifier circuit 122, and it is possible to implement the balance tuning of the physical quantity detection element 10.

On the other hand, during the operation of the physical quantity detection device 1, on the support substrate 30, the second wiring LS1B is coupled to the third wiring LS2A, and the fourth wiring LS2B is coupled to the first wiring LS1A. That is, the second wiring LS1B coupled to the second detection electrode ES1B of the first detection arms AS1 is coupled to the third wiring LS2A coupled to the third detection electrode ES2A of the second detection arm AS2. The fourth wiring LS2B coupled to the fourth detection electrode ES2B of the second detection arm AS2 is coupled to the first wiring LS1A coupled to the first detection electrode ES1A of the first detection arm AS1.

According to this configuration, the third detection electrode ES2A of the second detection arm AS2 and the second detection electrode ES1B of the first detection arm AS1 are coupled to each other via the third wiring LS2A and the second wiring LS1B. In addition, the first detection electrode ES1A of the first detection arm AS1 and the fourth detection electrode ES2B of the second detection arm AS2 are coupled to each other via the first wiring LS1A and the fourth wiring LS2B. Therefore, for example, during the operation after shipment as a product, similarly to FIG. 4, the first detection signal S1A from the first detection electrode ES1A and the fourth detection signal S2B from the fourth detection electrode ES2B can be input to the first amplifier circuit 121. Further, the third detection signal S2A from the third detection electrode ES2A and the second detection signal S1B from the second detection electrode ES1B can be input to the second amplifier circuit 122. Therefore, during the operation of the physical quantity detection device 1, it is possible to detect the physical quantity such as the angular velocity by the double wiring in which the area of the detection electrodes is doubled, and it is possible to improve the sensitivity or the like. The term “during the inspection” indicates, for example, the time when the physical quantity detection device 1 is inspected before product shipment, and the term “during the operation” indicates the time when the physical quantity detection device 1 is mounted on an electronic apparatus and operates after the product shipment.

### 4. Wiring Coupling on Support Substrate

Next, the wiring coupling on the support substrate 30 will be described in detail with reference to FIGS. 8 to 10. As described above, FIG. 8 illustrates an example of the wiring on the surface SF1 of the support substrate 30 during the inspection, and FIG. 9 illustrates an example of the wiring on the surface SF1 of the support substrate 30 during the operation. FIG. 10 illustrates an example of the wiring on the surface SF2 of the support substrate 30 during the inspection and during the operation.

The upper sides of FIGS. 8 and 9 correspond to the lower side of FIG. 10, and the lower sides of FIGS. 8 and 9 correspond to the upper side of FIG. 10. Therefore, in the following description, the lower sides in FIGS. 8 and 9 correspond to the upper side in FIG. 10, and the upper sides of FIGS. 8 and 9 correspond to the lower side in FIG. 10.

For example, the one end of the first wiring LS1A is coupled to the bonding member B2 for S1A in a lower right region of the element mounting portion 70 in FIGS. 8 and 9. Then, the first wiring LS1A extends through the beam portion 74, is wired on the surface SF2 of the support substrate 30, is folded back in an upper region of the inner periphery SD4 in FIG. 10, and is wired again in a lower region of the support portion 42 in FIGS. 8 and 9 on the surface SF1. The first wiring LS1A is coupled to a pad PS1A disposed in the lower region of the support portion 42 in FIGS. 8 and 9, is further wired on the surface SF1, is folded back in a lower region of the inner periphery SD4 in FIGS. 8 and 9, and is coupled to the terminal TS1A in an upper region of the support portion 42 in FIG. 10.

Further, one end of the second wiring LS1B is coupled to the bonding member B2 for S1B in a lower region of the element mounting portion 70 in FIGS. 8 and 9. Then, the second wiring LS1B extends through the beam portion 74, is wired on the surface SF2 of the support substrate 30, is folded back in the upper region of the inner periphery SD4 in FIG. 10, and is wired again in the lower region of the support portion 42 in FIGS. 8 and 9 on the surface SF1. The second wiring LS1B is coupled to a pad PS1B disposed in the lower region of the support portion 42 in FIGS. 8 and 9.

The one end of the third wiring LS2A is coupled to the bonding member B2 for S2A in an upper right region of the element mounting portion 70 in FIGS. 8 and 9. The third wiring LS2A extends through the beam portion 73, is wired on the surface SF2 of the support substrate 30, is folded back in the lower region of the inner periphery SD4 in FIG. 10, and is wired again in the upper region of the support portion 42 in FIGS. 8 and 9 on the surface SF1. The third wiring LS2A is coupled to a pad PS2A disposed in the upper region of the support portion 42 in FIGS. 8 and 9, is further wired on the surface SF1, is folded back in the upper region of the inner periphery SD4 in FIGS. 8 and 9, and is coupled to the terminal TS2A in the lower region of the support portion 42 in FIG. 10.

One end of the fourth wiring LS2B is coupled to the bonding member B2 for S2B in an upper region of the element mounting portion 70 in FIGS. 8 and 9. The fourth wiring LS2B extends through the beam portion 73, is wired on the surface SF2 of the support substrate 30, is folded back in the lower region of the inner periphery SD4 in FIG. 10, and is wired again in the upper region of the support portion 42 in FIGS. 8 and 9 on the surface SF1. The fourth wiring LS2B is coupled to a pad PS2B disposed in the upper region of the support portion 42 in FIGS. 8 and 9.

In addition, on the support substrate 30, the first ground wiring LG1 is wired in a lower region of the support portion 41 in FIGS. 8 and 9, and the second ground wiring LG2 is wired in an upper region of the support portion 41. The first ground wiring LG1 and the second ground wiring LG2 are formed of the metallic film 43 which is set to the electrical potential of the ground.

During the inspection of the physical quantity detection device 1, as illustrated in FIG. 8, the second wiring LS1B is coupled to the first ground wiring LG1 via the coupling line CSG1, and thus the second wiring LS1B is coupled to the ground. Further, during the inspection, as illustrated in FIG. 8, the fourth wiring LS2B is coupled to the second ground wiring LG2 via the coupling line CSG2, and thus the fourth wiring LS2B is coupled to the ground.

Since the second wiring LS1B is coupled to the ground in this manner, the second detection electrode ES1B of the first detection arm AS1 coupled to the second wiring LS1B is coupled to the ground. In addition, since the fourth wiring LS2B is coupled to the ground, the fourth detection electrode ES2B of the second detection arm AS2 coupled to the fourth wiring LS2B is coupled to the ground. As a result, the coupling configuration as illustrated in FIG. 6 is obtained, and balance tuning can be performed during the inspection.

On the other hand, during the operation of the physical quantity detection device 1, as illustrated in FIG. 9, the coupling between the second wiring LS1B and the first ground wiring LG1 is cut, and a cut trace CT1 remains between the second wiring LS1B and the first ground wiring LG1. Further, during the operation, as illustrated in FIG. 9, the coupling between the fourth wiring LS2B and the second ground wiring LG2 is cut, and a cut trace CT2 remains between the fourth wiring LS2B and the second ground wiring LG2.

For example, in the present embodiment, after the balance tuning, the coupling line CSG1 between the second wiring LS1B and the first ground wiring LG1 and the coupling line CSG2 between the fourth wiring LS2B and the second ground wiring LG2 are cut by irradiation with a laser beam or the like. As a result, the cut traces CSG1 and CSG2 remain at the cut positions of the coupling lines CT1 and CT2. As described above, the cut traces CT1 and CT2 indicate that the coupling between the second wiring LS1B and the ground and the coupling between the fourth wiring LS2B and the ground are cut after the balance tuning.

Note that the cutting of the coupling between the second wiring LS1B and the ground wiring and the cutting of the coupling between the fourth wiring LS2B and the ground wiring are not limited to such cutting by laser irradiation, and may be performed by irradiation with an energy beam other than a laser beam, such as an ion beam. Alternatively, fuse elements may be disposed between the second wiring LS1B and the ground wiring and between the fourth wiring LS2B and the ground wiring, and the coupling may be cut by passing an electrical current through the fuse elements. In addition, as the coupling lines CSG1 and CSG2 which couple the second wiring LS1B and the fourth wiring LS2B to the ground wiring, a metallic film which forms the ground wiring can be used. However, for example, conductive members such as a conductive adhesive other than the metallic film may be used as the coupling lines CSG1 and CSG2. Examples of a method for the coupling using the conductive members include an ink jet method, a coating method, and a bonding method. The ink jet method is an electrostatic ink jet method or a piezoelectric ink jet method, in which conductive ink or conductive paste is ejected. In the coating method, a conductive adhesive is applied.

During the operation of the physical quantity detection device 1, as illustrated in FIG. 9, the pad PS1B and the pad PS2A are coupled to each other by a bonding wire BW1, and the pad PS2B and the pad PS1A are coupled to each other by a bonding wire BW2. The pad PS1A is coupled to the first wiring LS1A, and the pad PS1B is coupled to the second wiring LS1B. The pad PS2A is coupled to the third wiring LS2A, and the pad PS2B is coupled to the fourth wiring LS2B. Therefore, since the pad PS1B and the pad PS2A are coupled to each other by the bonding wire BW1, the second wiring LS1B coupled to the pad PS1B is coupled to the third wiring LS2A coupled to the pad PS2A. Further, since the pad PS2B and the pad PS1A are coupled to each other by the bonding wire BW2, the fourth wiring LS2B coupled to the pad PS2B and the first wiring LS1A coupled to the pad PS1A are coupled to each other. As the bonding wires BW1 and BW2, for example, gold bonding wires or gold-alloy bonding wires can be used.

Since the second wiring LS1B and the third wiring LS2A are coupled to each other in this manner, the second detection electrode ES1B of the first detection arm AS1 coupled to the second wiring LS1B is coupled to the third detection electrode ES2A of the second detection arm AS2 coupled to the third wiring LS2A. In addition, since the fourth wiring LS2B and the first wiring LS1A are coupled to each other, the fourth detection electrode ES2B of the second detection arm AS2 coupled to the fourth wiring LS2B is coupled to the first detection electrode ES1A of the first detection arm AS1 coupled to the first wiring LS1A. As a result, the coupling configuration as illustrated in FIG. 4 is obtained, and the sensitivity can be improved by the double wiring during the operation.

Note that the coupling between the second wiring LS1B and the third wiring LS2A and the coupling between the fourth wiring LS2B and the first wiring LS1A for the operation are not limited to the bonding wires, and various coupling members can be used. For example, conductive members such as conductive adhesives may be used as the coupling members between the second wiring LS1B and the third LS2A and between the fourth wiring LS2B and the first wiring LS1A. For example, a first conductive member such as a first conductive adhesive may be formed between the second wiring LS1B and the third wiring LS2A to couple both the second wiring LS1B and the third wiring LS2A, and a second conductive member such as a second conductive adhesive may be formed between the fourth wiring LS2B and the first wiring LS1A to couple both the fourth wiring LS2B and the first wiring LS1A.

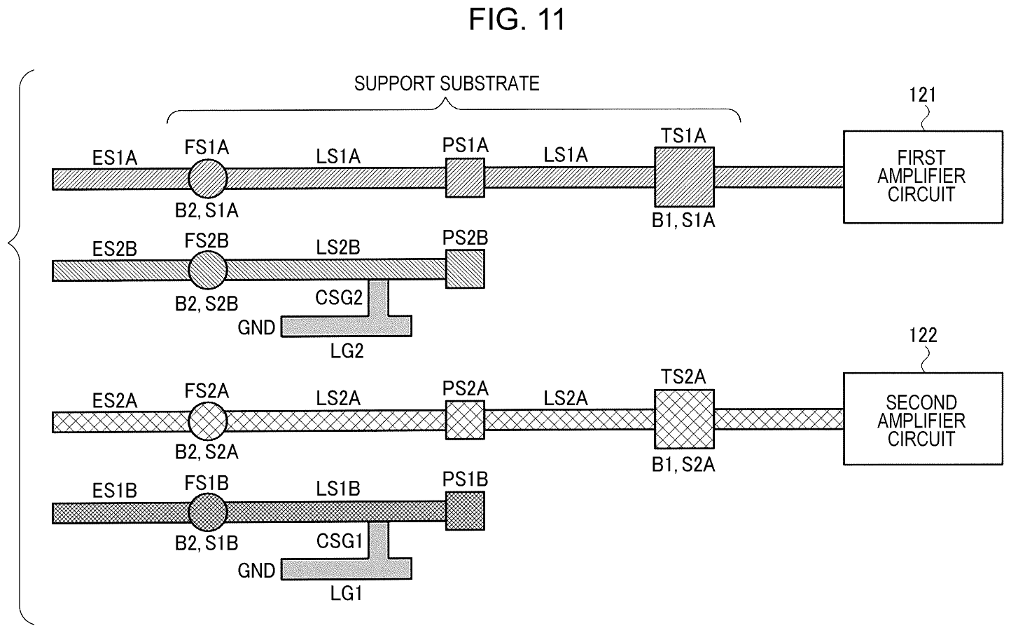

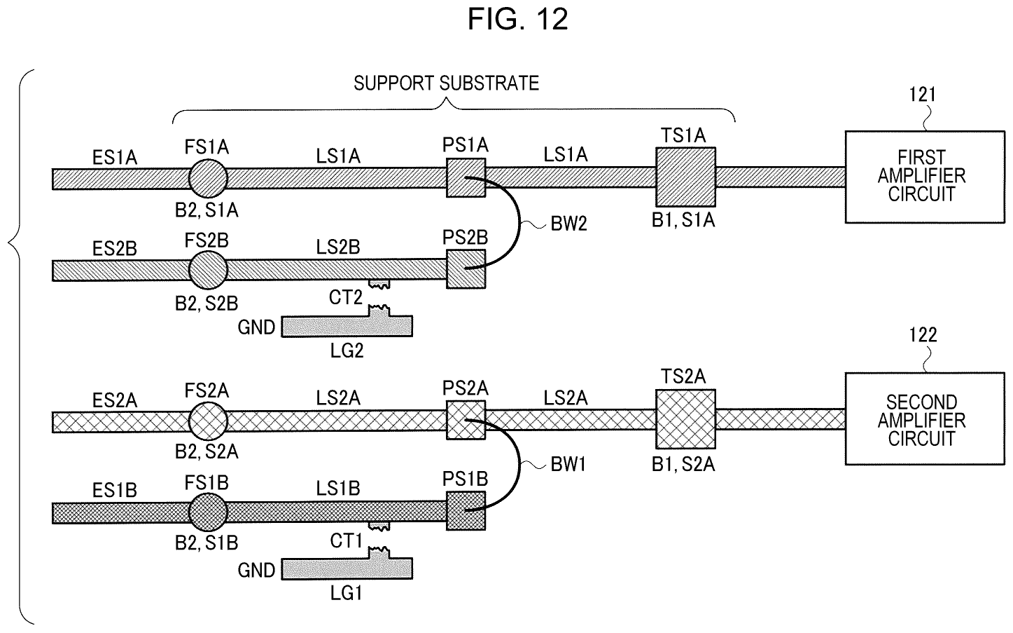

Next, the wiring coupling in the present embodiment will be described in a simplified manner with reference to FIGS. 11 and 12. FIG. 11 is a diagram schematically illustrating the wiring coupling during the inspection, and FIG. 12 is a diagram schematically illustrating the wiring coupling during the operation.

As illustrated in FIGS. 11 and 12, the first detection electrode ES1A is coupled to the one end of the first wiring LS1A of the support substrate 30 via the terminal FS1A of the physical quantity detection element 10 and the bonding member B2 for S1A. The first wiring LS1A is coupled to the pad PS1A, and the other end of the first wiring LS1A is electrically coupled to an input terminal of the first amplifier circuit 121 via the terminal TS1A of the support substrate 30 and the bonding member B1 for S1A.

In addition, the fourth detection electrode ES2B is coupled to the one end of the fourth wiring LS2B of the support substrate 30 via the terminal FS2B of the physical quantity detection element 10 and the bonding member B2 for S2B. The other end of the fourth wiring LS2B is coupled to the pad PS2B.

In addition, the third detection electrode ES2A is coupled to the one end of the third wiring LS2A of the support substrate 30 via the terminal FS2A of the physical quantity detection element 10 and the bonding member B2 for S2A. The third wiring LS2A is coupled to the pad PS2A, and the other end of the third wiring LS2A is electrically coupled to an input terminal of the second amplifier circuit 122 via the terminal TS2A of the support substrate 30 and the bonding member B1 for S2A.

In addition, the second detection electrode ES1B is coupled to the one end of the second wiring LS1B of the support substrate 30 via the terminal FS1B of the physical quantity detection element 10 and the bonding member B2 for S1B. The other end of the second wiring LS1B is coupled to the pad PS1B.

As illustrated in FIG. 11, during the inspection, the second wiring LS1B is coupled to the first ground wiring LG1 by the coupling line CSG1. As a result, the second detection electrode ES1B coupled to the second wiring LS1B is set to the ground. During the inspection, the fourth wiring LS2B is coupled to the second ground wiring LG2 by the coupling line CSG2. Accordingly, the fourth detection electrode ES2B coupled to the fourth wiring LS2B is set to the ground.

Accordingly, as in the coupling configuration illustrated in FIG. 6, the second detection electrode ES1B of the first detection arm AS1 and the fourth detection electrode ES2B of the second detection arm AS2 are set to the ground. In addition, the first detection signal S1A from the first detection electrode ES1A of the first detection arm AS1 is input to the first amplifier circuit 121, and the third detection signal S2A from the third detection electrode ES2A of the second detection arm AS2 are input to the second amplifier circuit 122. Therefore, the balance tuning can be performed by individually measuring an unnecessary signal due to an unnecessary vibration of the first detection arm AS1 and an unnecessary signal due to an unnecessary vibration of the second detection arm AS2.

On the other hand, as illustrated in FIG. 12, during the operation, the coupling between the second wiring LS1B and the first ground wiring LG1 is cut, and the second wiring LS1B is coupled to the third wiring LS2A via the bonding wire BW1. Further, during the operation, the coupling between the fourth wiring LS2B and the second ground wiring LG2 is cut, and the fourth wiring LS2B is coupled to the first wiring LS1A via the bonding wire BW2.

Accordingly, as in the coupling configuration illustrated in FIG. 4, the first detection signal S1A from the first detection electrode ES1A of the first detection arm AS1 and the fourth detection signal S2B from the fourth detection electrode ES2B of the second detection arm AS2 are input to the first amplifier circuit 121. In addition, the third detection signal S2A from the third detection electrode ES2A of the second detection arm AS2 and the second detection signal S1B from the second detection electrode ES1B of the first detection arm AS1 are input to the second amplifier circuit 122. Therefore, the signal obtained by summing the first detection signal S1A and the fourth detection signal S2B which have the identical phase is input to the first amplifier circuit 121, and the signal obtained by summing the third detection signal S2A and the second detection signal S1B which have the identical phase is input to the second amplifier circuit 122. Accordingly, the double wiring described with reference to FIG. 4 can be implemented, and the sensitivity of the physical quantity detection device 1 can be improved.

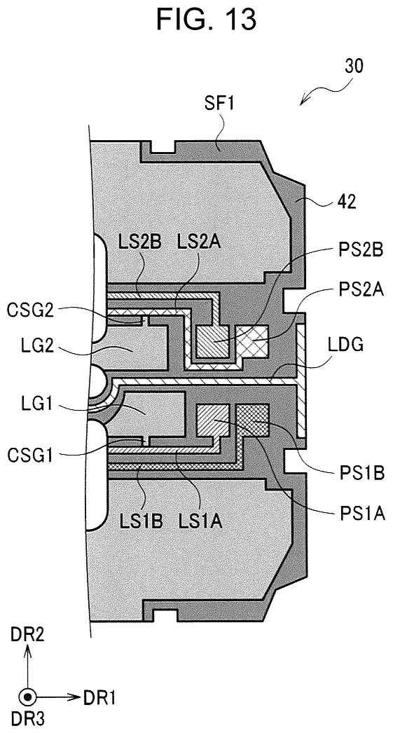

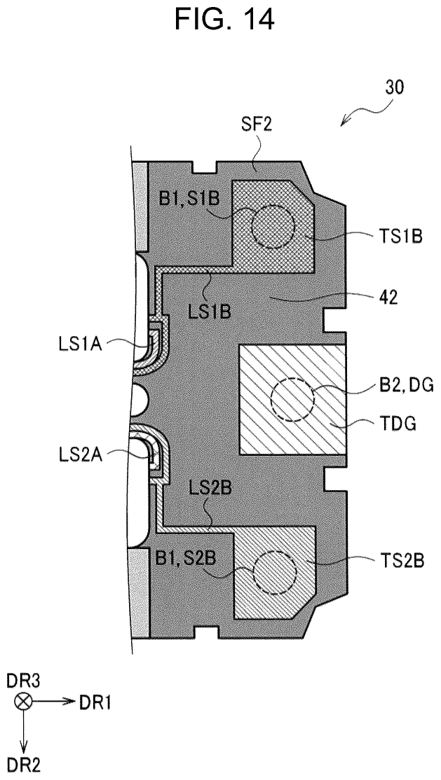

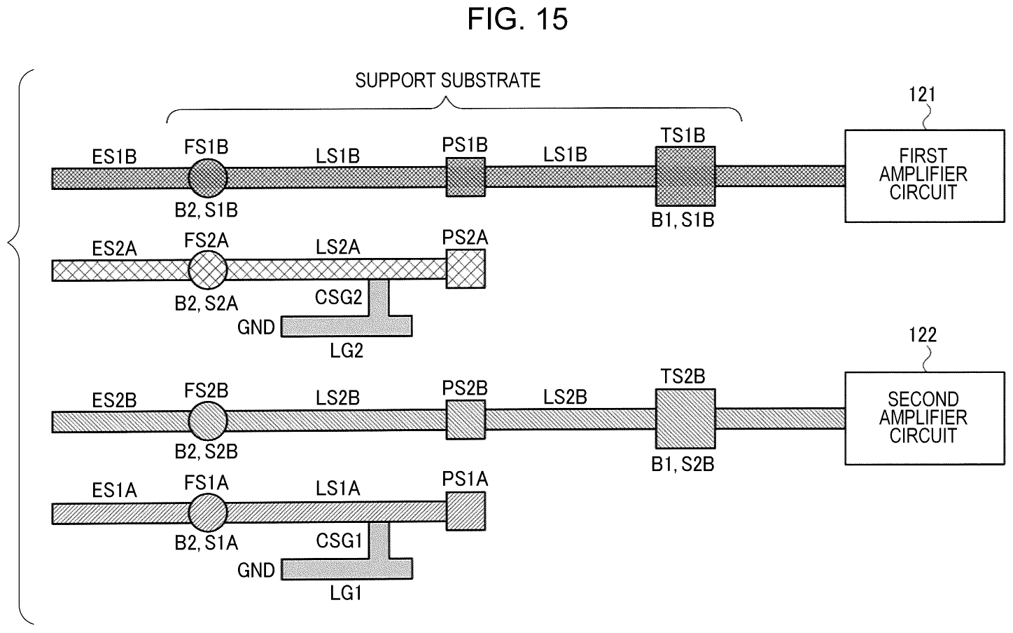

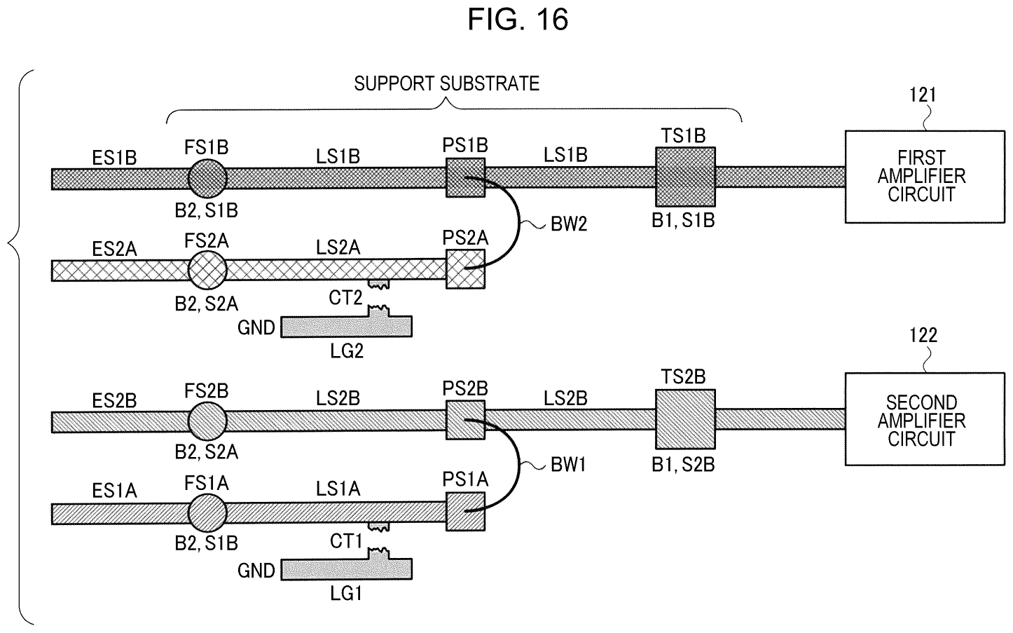

Various modifications can be made to the coupling wiring according to the present embodiment. For example, although the case where the wiring LS1B and the wiring LS2B are coupled to the ground during the inspection has been described above, the wiring LS1A and the wiring LS2A may be coupled to the ground. FIGS. 13 and 14 are diagrams illustrating a second wiring example that is an example of the wiring on the surfaces SF1 and SF2 of the support substrate 30 in the above-described case. FIGS. 15 and 16 are diagrams schematically illustrating wiring coupling in the second wiring example.

For example, as illustrated in FIG. 13, in the second wiring example, the wiring LS1A is coupled to the first ground wiring LG1 by the coupling line CSG1, and the wiring LS2A is coupled to the second ground wiring LG2 by the coupling line CSG2. In addition, as illustrated in FIG. 14, the one end of the wiring LS1B is coupled to a terminal TS1B of the support substrate 30, and the one end of the wiring LS2B is coupled to a terminal TS2B of the support substrate 30.

That is, during the inspection, as illustrated in FIG. 15, the wiring LS1A is coupled to the first ground wiring LG1 such that the electrode ES1A is coupled to the ground, and the wiring LS2A is coupled to the second ground wiring LG2 such that the electrode ES2A is coupled to the ground. A detection signal from the electrode ES1B is input to the first amplifier circuit 121, and a detection signal from the electrode ES2B is input to the second amplifier circuit 122.

Further, during the operation, as illustrated in FIG. 16, the wiring LS1A and the wiring LS2B are coupled to each other by the bonding wire BW1, and the wiring LS2A and the wiring LS1B are coupled to each other by the bonding wire BW2. Accordingly, a detection signal from the electrode ES1B and a detection signal from the electrode ES2A are summed and input to the first amplifier circuit 121, and a detection signal from the electrode ES2B and a detection signal from the electrode ES1A are summed and input to the second amplifier circuit 122.

In the second wiring example, for example, the electrodes ES1B, ES2A, ES2B, and ES1A illustrated in FIGS. 15 and 16 correspond to the first detection electrode, the fourth detection electrode, the third detection electrode, and the second detection electrode, respectively, and the wiring LS1B, the wiring LS2A, the wiring LS2B, and the wiring LS1A correspond to the first wiring, the fourth wiring, the third wiring, and the second wiring, respectively.

As described above, as illustrated in FIGS. 1 and 2, the physical quantity detection device 1 according to the present embodiment includes the physical quantity detection element 10, the support substrate 30, and the circuit device 20. The physical quantity detection element 10 includes the plurality of detection arms (19P and 19Q), the plurality of drive arms (18P to 18S), and the base portion 21, and the support substrate 30 supports the physical quantity detection element 10 at the base portion 21. The circuit device 20 includes the detection circuit 110 that detects a physical quantity based on a plurality of detection signals from the plurality of detection arms.

As illustrated in FIG. 7, the physical quantity detection element 10 includes the first detection arm AS1 (19P) and the second detection arm AS2 (190) as the plurality of detection arms. The first detection arm AS1 includes the first detection electrode ES1A and the second detection electrode ES1B and extends from the base portion 21. The second detection arm AS2 includes the third detection electrode ES2A and the fourth detection electrode ES2B and extends from the base portion 21 in a direction opposite to a direction in which the first detection arm AS1 extends from the base portion 21.

Further, as illustrated in FIGS. 2 to 4, the detection circuit 110 of the circuit device 20 includes the first amplifier circuit 121 and the second amplifier circuit 122. The first detection signal S1A from the first detection electrode ES1A and the fourth detection signal S2B from the fourth detection electrode ES2B are input to the first amplifier circuit 121 during the operation. In addition, the third detection signal S2A from the third detection electrode ES2A and the second detection signal S1B from the second detection electrode ES1B are input to the second amplifier circuit 122 during the operation.

As illustrated in FIGS. 8 to 12, the support substrate 30 includes the first wiring LS1A, the second wiring LS1B, the third wiring LS2A, and the fourth wiring LS2B. The one end of the first wiring LS1A is coupled to the first detection electrode ES1A, and the one end of the second wiring LS1B is coupled to the second detection electrode ES1B. The one end of the third wiring LS2A is coupled to the third detection electrode ES2A, and the one end of the fourth wiring LS2B is coupled to the fourth detection electrode ES2B.

In the present embodiment, on the support substrate 30, the second wiring LS1B is coupled to the ground during the inspection as illustrated in FIG. 11, and is coupled to the third wiring LS2A during the operation as illustrated in FIG. 12. In addition, on the support substrate 30, the fourth wiring LS2B is coupled to the ground during the inspection as illustrated in FIG. 11, and is coupled to the first wiring LS1A during the operation as illustrated in FIG. 12.

According to this configuration, during the inspection, the second wiring LS1B and the fourth wiring LS2B are coupled to the ground and thus the second detection electrode ES1B coupled to the second wiring LS1B and the fourth detection electrode ES2B coupled to the fourth wiring LS2B are coupled to the ground. Thus, the first detection signal S1A from the first detection electrode ES1A of the first detection arm AS1 is input to the first amplifier circuit 121, the third detection signal S2A from the third detection electrode ES2A of the second detection arm AS2 is input to the second amplifier circuit 122, and the detection signals of the first detection arm AS1 and the second detection arm AS2 are individually measured, whereby the balance tuning or the like can be implemented. In addition, during the operation, the first detection signal S1A from the first detection electrode ES1A and the fourth detection signal S2B from the fourth detection electrode ES2B can be input to the first amplifier circuit 121, and the third detection signal S2A from the third detection electrode ES2A and the second detection signal S1B from the second detection electrode ES1B can be input to the second amplifier circuit 122. As a result, for example, the sensitivity can be improved by the double wiring. Therefore, for example, both adjustment such as the balance tuning can be implemented and the sensitivity can be improved.

As illustrated in FIGS. 8 to 12, the support substrate 30 includes the first ground wiring LG1 and the second ground wiring LG2. As illustrated in FIGS. 8 and 11, during the inspection, the first ground wiring LG1 and the second wiring LS1B are coupled to each other, and the second ground wiring LG2 and the fourth wiring LS2B are coupled to each other. According to this configuration, during the inspection, the first ground wiring LG1 and the second wiring LS1B are coupled to each other, whereby the second wiring LS1B is coupled to the ground, and the second detection electrode ES1B coupled to the second wiring LS1B is set to the electrical potential of the ground. Further, during the inspection, the second ground wiring LG2 and the fourth wiring LS2B are coupled to each other, whereby the fourth wiring LS2B is coupled to the ground, and the fourth detection electrode ES2B coupled to the fourth wiring LS2B is set to the electrical potential of the ground. This makes it possible to implement the balance tuning or the like. The first ground wiring and the second ground wiring may be the same wiring.

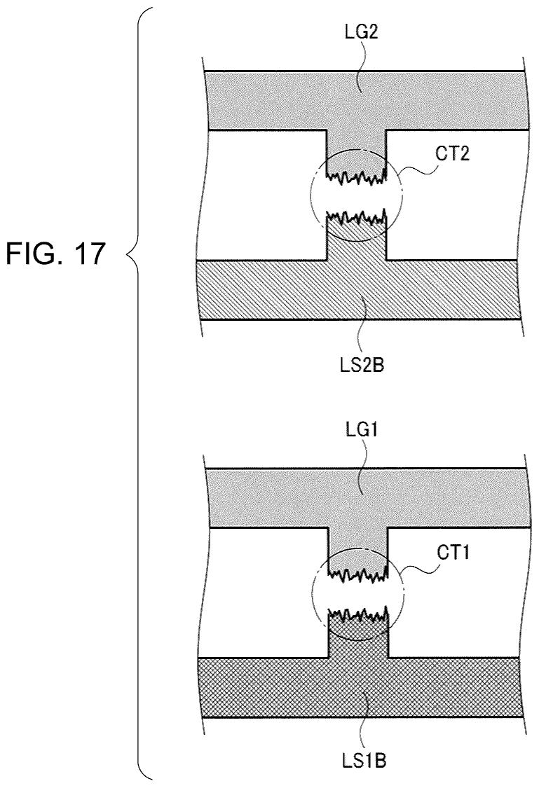

Further, in the present embodiment, as illustrated in FIGS. 17 and 9, the support substrate 30 has the cut trace CT1 between the second wiring LS1B and the first ground wiring LG1, and has the cut trace CT2 between the fourth wiring LS2B and the second ground wiring LG2. The cut trace CT1 is a first cut trace, and the cut trace CT2 is a second cut trace. The fact that the support substrate 30 has the cut traces CT1 and CT2 indicates that the second wiring LS1B and the fourth wiring LS2B are coupled to the ground during the inspection and are cut after the inspection.

As illustrated in FIGS. 8 to 12, the support substrate 30 includes the terminal TS1A to be coupled to the first input node N1 of the amplifier circuit 120, and the terminal TS2A to be coupled to the second input node N2 of the amplifier circuit 120. The terminal TS1A is a first terminal, and the terminal TS2A is a second terminal. The terminal TS1A is coupled to the first wiring LS1A, and the terminal TS2A is coupled to the third wiring LS2A. That is, as illustrated in FIGS. 11 and 12, the terminal TS1A of the support substrate 30 coupled to the first amplifier circuit 121 is coupled to the first wiring LS1A, and the terminal TS2A of the support substrate 30 coupled to the second amplifier circuit 122 is coupled to the third wiring LS2A. For example, the terminal TS1A is coupled to the input terminal of the first amplifier circuit 121 for the first detection signal S1A via the bonding member B1 for S1A, wiring in the package, and the like. In addition, the terminal TS2A is coupled to the input terminal of the second amplifier circuit 122 for the third detection signal S2A via the bonding member B1 for S2A, wiring in the package, and the like.

According to this configuration, the first detection signal S1A from the first detection electrode ES1A of the first detection arm AS1 can be input to the first amplifier circuit 121 via the first wiring LS1A and the terminal TS1A. In addition, the third detection signal S2A from the third detection electrode ES2A of the second detection arm AS2 can be input to the second amplifier circuit 122 via the third wiring LS2A and the terminal TS2A.

As illustrated in FIGS. 8 to 12, the second wiring LS1B is not coupled to the terminal TS2A as the second terminal during the inspection, and the fourth wiring LS2B is not coupled to the terminal TS1A as the first terminal during the inspection. For example, during the operation illustrated in FIG. 12, the second wiring LS1B is coupled to the terminal TS2A via the bonding wire BW1 or the like, but during the inspection illustrated in FIG. 11, the second wiring LS1B is not coupled to the terminal TS2A. During the operation illustrated in FIG. 12, the fourth wiring LS2B is coupled to the terminal TS1A via the bonding wire BW2 or the like, but during the inspection illustrated in FIG. 11, the fourth wiring LS2B is not coupled to the terminal TS1A.

In this way, during the inspection, the second detection electrode ES1B coupled to the second wiring LS1B is not electrically coupled to the second amplifier circuit 122 via the terminal TS2A. During the inspection, the fourth detection electrode ES2B coupled to the fourth wiring LS2B is not electrically coupled to the first amplifier circuit 121 via the terminal TS1A. Thus, during the inspection, a detection signal from the first detection arm AS1 and a detection signal from the second detection arm AS2 can be individually measured, and adjustment such as the balance tuning can be performed.

As illustrated in FIGS. 8 to 12, the support substrate 30 includes the pad PS1A coupled to the first wiring LS1A, the pad PS1B coupled to the second wiring LS1B, the pad PS2A coupled to the third wiring LS2A, and the pad PS2B coupled to the fourth wiring LS2B. The pads PS1A, PS1B, PS2A, and PS2B are a first pad, a second pad, a third pad, and a fourth pad, respectively. As illustrated in FIG. 12, during the operation, the pad PS1B and the pad PS2A are coupled to each other, and the pad PS2B and the pad PS1A are coupled to each other.

According to this configuration, the second wiring LS1B and the third wiring LS2A can be coupled to each other by coupling the pad PS1B and the pad PS2A, and the fourth wiring LS2B and the first wiring LS1A can be coupled to each other by coupling the pad PS2B and the pad PS1A. By providing the pads PS1A, PS1B, PS2A, and PS2B on the support substrate 30, the second wiring and the third wiring can be easily coupled to each other and the fourth wiring and the first wiring can be easily coupled to each other after the inspection.

Further, as illustrated in FIG. 12, the pad PS1B and the pad PS2A are coupled to each other by the bonding wire BW1, and the pad PS2B and the pad PS1A are coupled to each other by the bonding wire BW2. The bonding wires BW1 and BW2 are a first bonding wire and a second bonding wire, respectively.

According to this configuration, the second wiring LS1B and the third wiring LS2A can be coupled to each other by coupling the pad PS1B and the pad PS2A to each other by the bonding wire BW1, and the fourth wiring LS2B and the first wiring LS1A can be coupled to each other by coupling the pad PS2B and the pad PS1A to each other by the bonding wire BW2. When the bonding wires BW1 and BW2 are used, even if other wiring is present between the second wiring LS1B and the third wiring LS2A and between the fourth wiring LS2B and the first wiring LS1A, the wiring can be easily coupled by the bonding wires BW1 and BW2 above the other wiring.

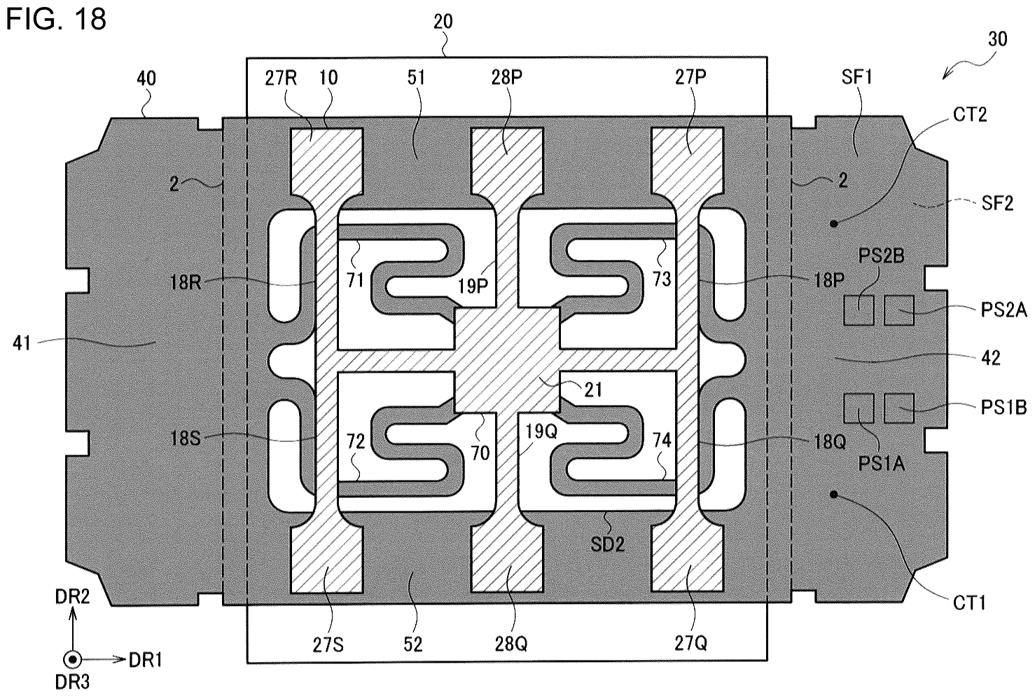

FIG. 18 illustrates an example of an arrangement relationship between the support substrate 30, the physical quantity detection element 10, and the circuit device 20. As illustrated in FIG. 18, the physical quantity detection element 10 is disposed on the surface SF1 side of the support substrate 30. Further, the circuit device 20 is disposed on the surface SF2 side of the support substrate 30. That is, the support substrate 30 is disposed between the physical quantity detection element 10 and the circuit device 20.

As described with reference to FIG. 17, the support substrate 30 has the cut trace CT1 between the second wiring LS1B and the first ground wiring LG1 and has the cut trace CT2 between the fourth wiring LS2B and the second ground wiring LG2.

In this case, as illustrated in FIG. 18, the cut traces CT1 and CT2 do not overlap the physical quantity detection element 10 in plan view. The plan view is, for example, a plan view in a direction orthogonal to the support substrate 30, and is a plan view in the direction DR3. For example, the physical quantity detection element 10 includes members such as the base portion 21, the drive arms 18P to 18S, the detection arms 19P and 19Q, and the weight portions 27P to 27S, but as illustrated in FIG. 18, the cut traces CT1 and CT2 are formed at positions where the cut traces CT1 and CT2 do not overlap any of these members in plan view.

Further, as illustrated in FIG. 18, the cut traces CT1 and CT2 do not overlap the circuit device 20 in plan view. However, a plurality of circuits are disposed in the circuit device 20 that is, for example, a semiconductor chip, but the cut traces CT1 and CT2 are formed at positions where the cut traces CT1 and CT2 do not overlap any of these circuits in plan view.

According to this configuration, even when the coupling between the second wiring LS1B and the first ground wiring LG1 and the coupling between the fourth wiring LS2B and the second ground wiring LG2 are cut, it is possible to implement the physical quantity detection device 1 capable of preventing the occurrence of a failure caused by the cutting. For example, when the coupling between the second wiring LS1B and the first ground wiring LG1 and the coupling between the fourth wiring LS2B and the second ground wiring LG2 are cut by an energy beam such as a laser beam, and the physical quantity detection element 10 or the circuit device 20 is irradiated with the energy beam, the element characteristics of the physical quantity detection element 10 may be adversely affected by the irradiation or the circuit characteristics of the circuit device 20 may be adversely affected by the irradiation. For example, a defect such as degradation of the vibration characteristics of the physical quantity detection element 10 or degradation of the circuit characteristics of the circuit device 20 may occur. In this regard, FIG. 18 illustrates that the cut traces CT1 and CT2 are formed at positions where the physical quantity detection element 10 and the circuit device 20 are not irradiated with an energy beam such as a laser beam, and the physical quantity detection element 10 and the circuit device 20 are not irradiated with the energy beam. Therefore, it is possible to implement the physical quantity detection device 1 capable of preventing the occurrence of a failure caused by the cutting of the coupling between the wiring and the ground wiring with the energy beam.

As illustrated in FIG. 1, the physical quantity detection device 1 includes the package 4 in which the physical quantity detection element 10, the support substrate 30, and the circuit device 20 are accommodated. The package 4 includes, for example, the base 2 and the lid 3. In this case, the cut trace CT1 and the cut trace CT2 overlap the base 2 of the package 4 in plan view, for example. For example, dotted lines illustrated in FIG. 18 and corresponding to the base 2 correspond to, for example, the step portions of the base 2 and the like in FIG. 1. The base 2 is located below the cut traces CT1 and CT2 (on the side opposite to the direction DR3) without other members or elements such as terminals interposed between the base 2 and the cut traces CT1 and CT2. When the base 2 is formed of, for example, ceramic or the like, there is no problem even if irradiation with an energy beam for cutting the wiring and the ground wiring occurs. Therefore, since the cut traces CT1 and CT2 overlap the base 2 in plan view, it is possible to implement the physical quantity detection device 1 capable of preventing the occurrence of a defect caused by irradiation with an energy beam such as a laser beam.

In addition, in the present embodiment, as described with reference to FIGS. 8 and 9, the pads PS1A, PS1B, PS2A, and PS2B which are terminals for coupling the wiring are disposed on the support substrate 30. The pads PS1A, PS1B, PS2A, and PS2B are the first pad, the second pad, the third pad, and the fourth pad, respectively, and are coupled to the wiring LS1A, LS1B, LS2A, and LS2B, respectively.

In FIG. 18, the pads PS1A, PS1B, PS2A, and PS2B do not overlap the physical quantity detection element 10 in plan view. For example, the pads PS1A, PS1B, PS2A, and PS2B are formed at positions where the pads PS1A, PS1B, PS2A, and PS2B do not overlap the members constituting the physical quantity detection element 10 in plan view.

In FIG. 18, the pads PS1A, PS1B, PS2A, and PS2B do not overlap the circuit device 20 in plan view. For example, the pads PS1A, PS1B, PS2A, and PS2B are formed at positions where the pads PS1A, PS1B, PS2A, and PS2B do not overlap the circuits constituting the circuit device 20 in plan view.

In this way, even when wiring coupling using the pads PS1A, PS1B, PS2A, and PS2B is performed, it is possible to implement the physical quantity detection device 1 capable of preventing the occurrence of a failure caused by the wiring coupling. For example, in FIGS. 9 and 12, the pad PS1B and the pad PS2A are coupled to each other by the bonding wire BW1, and the pad PS2B and the pad PS1A are coupled to each other by the bonding wire BW2. In this case, when pressure or impact due to the coupling of the bonding wires BW1 and BW2 is applied to the physical quantity detection element 10 or the circuit device 20, the element characteristics of the physical quantity detection element 10 or the circuit characteristics of the circuit device 20 may be adversely affected by the pressure or the impact. For example, a defect such as degradation of the vibration characteristics of the physical quantity detection element 10 or degradation of the circuit characteristics of the circuit device 20 may occur. In this regard, in FIG. 18, the pads PS1A, PS1B, PS2A, and PS2B are formed at positions where pressure or impact due to the coupling of the bonding wires BW1 and BW2 is not applied to the physical quantity detection element 10 and the circuit device 20. Therefore, it is possible to implement the physical quantity detection device 1 capable of preventing the occurrence of a failure caused by the wiring coupling using the pads PS1A, PS1B, PS2A, and PS2B.

In FIG. 18, the pads PS1A, PS1B, PS2A, and PS2B overlap the base 2 of the package 4 in plan view, for example. For example, the base 2 is located below the pads PS1A, PS1B, PS2A, and PS2B (on the side opposite to the direction DR3) without other members or elements such as terminals interposed between the base 2 and the pads PS1A, PS1B, PS2A, and PS2B. When the base 2 is formed of, for example, ceramic or the like, there is no problem even if pressure or impact is applied due to the wiring coupling using the bonding wires BW1 and BW2 or the like. Therefore, since the base 2 overlaps the pads PS1A, PS1B, PS2A, and PS2B in plan view, it is possible to implement the physical quantity detection device 1 capable of preventing the occurrence of a failure caused by the wiring coupling using the bonding wires BW1 and BW2 or the like.

### 5. Manufacturing Method

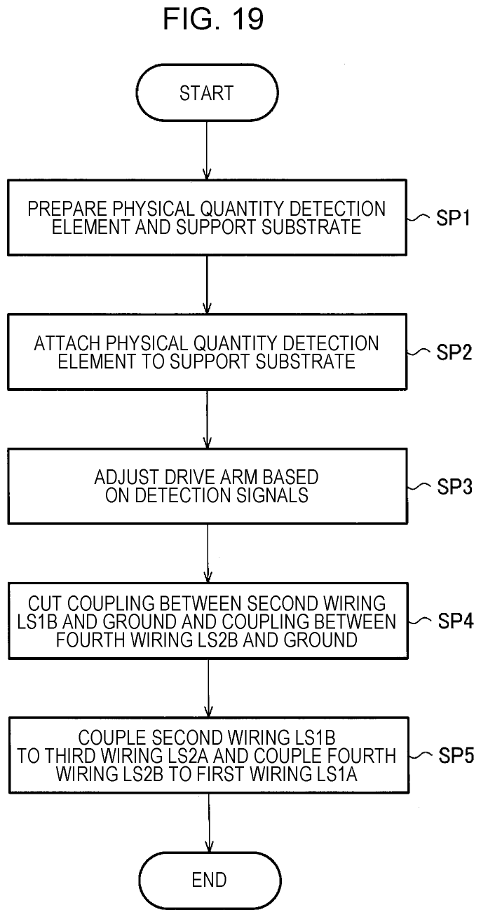

Next, an example of a method of manufacturing the physical quantity detection device 1 according to the present embodiment will be described with reference to FIG. 19. As illustrated in FIG. 19, in SP1, the physical quantity detection element 10 and the support substrate 30 are prepared. As illustrated in FIGS. 8 and 11, on the support substrate 30, the second wiring LS1B and the first ground wiring LG1 are coupled to each other by the coupling line CSG1, and the fourth wiring LS2B and the second ground wiring LG2 are coupled to each other by the coupling line CSG2. Further, the pad PS1B and the pad PS2A are not coupled to each other and the pad PS2B and the pad PS1A are not coupled to each other, and a coupling member such as a bonding wire is not disposed between the pad PS1B and the pad PS2A and between the pad PS2B and the pad PS1A.

In SP2, the physical quantity detection element 10 is attached to the support substrate 30. Specifically, in FIG. 1, first, the support substrate 30 is mounted on the package 4. For example, the support substrate 30 is bonded and attached to the step portion of the recess 9A of the base 2 of the package 4 by using the bonding members B1. Then, the physical quantity detection element 10 is bonded and attached to the support substrate 30 attached to the base 2 using the bonding members B2.

In SP3, a drive arm is adjusted based on detection signals. In detail, in FIG. 11, the first detection signal S1A from the first detection electrode ES1A of the first detection arm AS1 is input to the first amplifier circuit 121, and an unnecessary signal due to an unnecessary vibration of the first detection arm AS1 is measured. In addition, the third detection signal S2A from the third detection electrode ES2A of the second detection arm AS2 is input to the second amplifier circuit 122, and an unnecessary signal due to an unnecessary vibration of the second detection arm AS2 is measured. Then, at least one of the drive arms 18P to 18S in FIG. 2 is adjusted based on the results of measuring these unnecessary signals. That is, the balance tuning is performed. To be specific, a gold film of, for example, about 1 μm formed on the weight portions 27P to 27S of the tip end portions of the drive arms 18P to 18S is irradiated with an energy beam such as a laser beam to remove a portion of the gold film. A frequency is increased by removing the portion of the gold film. Alternatively, a gold film may be formed by sputtering or vapor deposition using a metal mask to lower the frequency.

In the balance tuning, while the detection signals generated due to the unnecessary vibrations are measured, the mass of the weight portion disposed at each drive arm is changed and adjusted to reduce the unnecessary vibrations. In addition, in the balance tuning, the unnecessary signals generated from the two detection arms are separately measured, and the amount of processing on the drive arm is calculated according to the measured values. In this manner, by changing the mass of the weight portion, it is possible to adjust the frequency generated by the drive arm, and it is possible to suppress the generation of unnecessary signals due to unnecessary vibrations of the detection arms. In addition, since the balance tuning is performed after the physical quantity detection element 10 is mounted on the package 4 or the support substrate 30, it is possible to provide the physical quantity detection device 1 with higher reliability. In addition, since the detection signals are amplified by the first amplifier circuit 121 and the second amplifier circuit 122, even slight unnecessary signals detected by the detection electrodes can be reliably measured.

In SP4, the coupling between the second wiring LS1B and the ground and the coupling between the fourth wiring LS2B and the ground are cut. To be specific, as illustrated in FIGS. 9 and 12, the coupling between the second wiring LS1B and the first ground wiring LG1 is cut, and the coupling between the fourth wiring LS2B and the second ground wiring LG2 is cut. For example, the coupling lines CSG1 and CSG2 in FIGS. 8 and 11 are irradiated with an energy beam such as a laser beam to cut the coupling between the wiring and the ground wiring. When the cut traces CT1 and CT2 as illustrated in FIGS. 9, 12, and 17 are left, it is found that the coupling between the wiring and the ground wiring was cut.

In SP5, the second wiring LS1B is coupled to the third wiring LS2A, and the fourth wiring LS2B is coupled to the first wiring LS1A. To be specific, as illustrated in FIGS. 9 and 12, the second wiring LS1B is coupled to the third wiring LS2A by coupling the pad PS1B coupled to the second wiring LS1B and the pad PS2A coupled to the third wiring LS2A by the bonding wire BW1. Further, the fourth wiring LS2B is coupled to the first wiring LS1A by coupling the pad PS2B coupled to the fourth wiring LS2B and the pad PS1A coupled to the first wiring LS1A by the bonding wire BW2.

As described above, the manufacturing method according to the present embodiment includes preparing the physical quantity detection element 10 and the support substrate 30 (SP1), attaching the physical quantity detection element 10 to the support substrate 30 (SP2), and adjusting at least one of the plurality of drive arms (SP3) in the method of manufacturing the physical quantity detection device 1 described with reference to FIGS. 1 to 18. Further, the manufacturing method according to the present embodiment includes cutting the coupling between the second wiring LS1B and the ground and the coupling between the fourth wiring LS2B and the ground (SP4), and coupling the second wiring LS1B to the third wiring LS2A and coupling the fourth wiring LS2B to the first wiring LS1A (SP5).

In this way, for example, before SP4, the second wiring LS1B and the ground are coupled to each other, and the fourth wiring LS2B and the ground are coupled to each other. Accordingly, the first detection signal S1A from the first detection electrode ES1A of the first detection arm AS1 is input to the first amplifier circuit 121, the third detection signal S2A from the third detection electrode ES2A of the second detection arm AS2 is input to the second amplifier circuit 122, and the detection signals of the first detection arm AS1 and the second detection arm AS2 are individually measured, whereby the balance tuning or the like can be implemented. In addition, after SP4 and SP5, the coupling between the second wiring LS1B and the ground and the coupling between the fourth wiring LS2B and the ground are cut, the second wiring LS1B is coupled to the third wiring LS2A, and the fourth wiring LS2B is coupled to the first wiring LS1A. Therefore, the first detection signal S1A from the first detection electrode ES1A and the fourth detection signal S2B from the fourth detection electrode ES2B can be input to the first amplifier circuit 121, and the third detection signal S2A from the third detection electrode ES2A and the second detection signal S1B from the second detection electrode ES1B can be input to the second amplifier circuit 122. As a result, for example, the sensitivity can be improved by the double wiring.

As described above, the physical quantity detection device according to the present embodiment includes the physical quantity detection element including the plurality of detection arms, the plurality of drive arms, and the base portion, the support substrate that supports the physical quantity detection element at the base portion, and the circuit device including the detection circuit that detects a physical quantity based on a plurality of detection signals from the plurality of detection arms of the physical quantity detection element. The physical quantity detection element includes, as the plurality of detection arms, the first detection arm including the first detection electrode and the second detection electrode and extending from the base portion, and the second detection arm including the third detection electrode and the fourth detection electrode and extending from the base portion in the direction opposite to the direction in which the first detection arm extends from the base portion. The detection circuit of the circuit device includes the first amplifier circuit to which the first detection signal from the first detection electrode and the fourth detection signal from the fourth detection electrode are input during the operation, and the second amplifier circuit to which the third detection signal from the third detection electrode and the second detection signal from the second detection electrode are input during the operation. In addition, the support substrate includes the first wiring having one end coupled to the first detection electrode, the second wiring having one end coupled to the second detection electrode, the third wiring having one end coupled to the third detection electrode, and the fourth wiring having one end coupled to the fourth detection electrode. The second wiring is coupled to the ground during the inspection and coupled to the third wiring during the operation on the support substrate, and the fourth wiring is coupled to the ground during the inspection and coupled to the first wiring during the operation on the support substrate.

According to the present embodiment, during the inspection, the second wiring and the fourth wiring are coupled to the ground, and thus the second detection electrode coupled to the second wiring and the fourth detection electrode coupled to the fourth wiring are coupled to the ground. Accordingly, the first detection signal from the first detection electrode of the first detection arm is input to the first amplifier circuit, the third detection signal from the third detection electrode of the second detection arm is input to the second amplifier circuit, and the detection signals of the first detection arm and the second detection arm can be individually measured. During the operation, the second wiring is coupled to the third wiring, and the fourth wiring is coupled to the first wiring. Therefore, the first detection signal from the first detection electrode and the fourth detection signal from the fourth detection electrode can be input to the first amplifier circuit, and the third detection signal from the third detection electrode and the second detection signal from the second detection electrode can be input to the second amplifier circuit, so that the sensitivity and the like can be improved.

In the present embodiment, the support substrate may include the first ground wiring and the second ground wiring, and during the inspection, the first ground wiring and the second wiring may be coupled to each other, and the second ground wiring and the fourth wiring may be coupled to each other.

According to this configuration, during the inspection, the second wiring is coupled to the ground by coupling the first ground wiring and the second wiring, and the fourth wiring is coupled to the ground by coupling the second ground wiring and the fourth wiring.

In the present embodiment, the support substrate may have the first cut trace between the second wiring and the first ground wiring, and the second cut trace between the fourth wiring and the second ground wiring.

Since the support substrate has the first cutting trace and the second cutting trace, it is indicated that the second wiring and the fourth wiring were coupled to the ground during the inspection.

In the present embodiment, the first cutting trace and the second cutting trace may not overlap the physical quantity detection element in plan view.

According to this configuration, even when the coupling between the second wiring and the first ground wiring and the coupling between the fourth wiring and the second ground wiring are cut, it is possible to prevent the physical quantity detection element from being adversely affected by the cutting.

In the present embodiment, the first cut trace and the second cut trace may not overlap the circuit device in plan view.

According to this configuration, even when the coupling between the second wiring and the first ground wiring and the coupling between the fourth wiring and the second ground wiring are cut, it is possible to prevent the circuit device from being adversely affected by the cutting.

In the present embodiment, the support substrate may include the first terminal to be coupled to the first amplifier circuit and the second terminal to be coupled to the second amplifier circuit, the first terminal may be coupled to the first wiring, and the second terminal may be coupled to the third wiring.

According to this configuration, the first detection signal from the first detection electrode of the first detection arm can be input to the first amplifier circuit via the first wiring and the first terminal. In addition, the third detection signal from the third detection electrode of the second detection arm can be input to the second amplifier circuit via the third wiring and the second terminal.

In addition, in the present embodiment, the second wiring may not be coupled to the second terminal during the inspection, and the fourth wiring may not be coupled to the first terminal during the inspection.

According to this configuration, during the inspection, the second detection electrode coupled to the second wiring is not electrically coupled to the second amplifier circuit via the first terminal, and the fourth detection electrode coupled to the fourth wiring is not electrically coupled to the first amplifier circuit via the second terminal.

In the present embodiment, the support substrate may include the first pad coupled to the first wiring, the second pad coupled to the second wiring, the third pad coupled to the third wiring, and the fourth pad coupled to the fourth wiring, and during the operation, the second pad and the third pad may be coupled to each other, and the fourth pad and the first pad may be coupled to each other.

According to this configuration, the second wiring and the third wiring can be coupled by coupling the second pad and the third pad, and the fourth wiring and the first wiring can be coupled by coupling the fourth pad and the first pad.

In addition, in the present embodiment, the second pad and the third pad may be coupled to each other by the first bonding wire, and the fourth pad and the first pad may be coupled to each other by the second bonding wire.

According to this configuration, the second wiring and the third wiring can be coupled by coupling the second pad and the third pad by the first bonding wire, and the fourth wiring and the first wiring can be coupled by coupling the fourth pad and the first pad by the second bonding wire.

In the present embodiment, the first pad, the second pad, the third pad, and the fourth pad may not overlap the physical quantity detection element in plan view.

According to this configuration, even when the wiring coupling using the first pad, the second pad, the third pad, and the fourth pad is performed, it is possible to prevent the physical quantity detection element from being adversely affected by the wiring coupling.

Further, in the present embodiment, the first pad, the second pad, the third pad, and the fourth pad may not overlap the circuit device in plan view.

According to this configuration, even when the wiring coupling using the first pad, the second pad, the third pad, and the fourth pad is performed, it is possible to prevent the circuit device from being adversely affected by the wiring coupling.

The manufacturing method according to the present embodiment is the method of manufacturing the physical quantity detection device including the physical quantity detection element including the plurality of detection arms, the plurality of drive arms, and the base portion, the support substrate that supports the physical quantity detection element at the base portion, and the circuit device including the detection circuit that detects a physical quantity based on a plurality of detection signals from the plurality of detection arms of the physical quantity detection element. The physical quantity detection element includes, as the plurality of detection arms, the first detection arm including the first detection electrode and the second detection electrode and extending from the base portion, and the second detection arm including the third detection electrode and the fourth detection electrode and extending from the base portion in the direction opposite to the direction in which the first detection arm extends from the base portion. In addition, the detection circuit of the circuit device includes the amplifier circuit in which, during the operation, the first detection signal from the first detection electrode and the fourth detection signal from the fourth detection electrode are input to the first input node, and the third detection signal from the third detection electrode and the second detection signal from the second detection electrode are input to the second input node. In addition, the support substrate includes the first wiring having one end coupled to the first detection electrode, the second wiring having one end coupled to the second detection electrode, the third wiring having one end coupled to the third detection electrode, and the fourth wiring having one end coupled to the fourth detection electrode. The manufacturing method according to the present embodiment includes preparing the physical quantity detection element and the support substrate, attaching the physical quantity detection element to the support substrate, and adjusting at least one of the plurality of drive arms. The manufacturing method according to the present embodiment further includes cutting the coupling between the second wiring and the ground and the coupling between the fourth wiring and the ground, and coupling the second wiring to the third wiring and coupling the fourth wiring to the first wiring.

According to this method, before the cutting of the coupling between the second wiring and the ground and the coupling between the fourth wiring and the ground, the first detection signal from the first detection electrode of the first detection arm is input to the first amplifier circuit, the third detection signal from the third detection electrode of the second detection arm is input to the second amplifier circuit, and the detection signals of the first detection arm and the second detection arm can be individually measured. Further, after the cutting of the coupling between the second wiring and the ground and the coupling between the fourth wiring and the ground and after the coupling of the second wiring to the third wiring and coupling of the fourth wiring to the first wiring, the first detection signal from the first detection electrode and the fourth detection signal from the fourth detection electrode can be input to the first amplifier circuit, and the third detection signal from the third detection electrode and the second detection signal from the second detection electrode can be input to the second amplifier circuit.

Although the present embodiment has been described in detail above, it will be easily understood by those skilled in the art that various modifications can be made without substantially departing from the novel features and effects of the present disclosure. Therefore, all such modifications are included in the scope of the present disclosure. For example, a term described together with a different term having a broader meaning or the same meaning at least once in the specification or the drawings can be replaced with the different term in any section in the specification or the drawings. In addition, the configurations and the like of the physical quantity detection device, the support substrate, the physical quantity detection element, and the circuit device are not limited to those described in the present embodiment, and various modifications can be implemented.

What is claimed is:

1. A physical quantity detection device comprising:
a physical quantity detection element including a plurality of detection arms, a plurality of drive arms, and a base portion;
a support substrate that supports the physical quantity detection element at the base portion; and
a circuit device including a detection circuit that detects a physical quantity based on a plurality of detection signals from the plurality of detection arms of the physical quantity detection element, wherein
the physical quantity detection element includes, as the plurality of detection arms,
a first detection arm including a first detection electrode and a second detection electrode and extending from the base portion, and
a second detection arm including a third detection electrode and a fourth detection electrode and extending from the base portion in a direction opposite to a direction in which the first detection arm extends from the base portion;
the detection circuit of the circuit device includes
an amplifier circuit in which, during operation, a first detection signal from the first detection electrode and a fourth detection signal from the fourth detection electrode are input to a first input node, and a third detection signal from the third detection electrode and a second detection signal from the second detection electrode are input to a second input node,
the support substrate includes
first wiring having one end coupled to the first detection electrode,
second wiring having one end coupled to the second detection electrode,
third wiring having one end coupled to the third detection electrode, and
fourth wiring having one end coupled to the fourth detection electrode,
the second wiring is coupled to ground during inspection and coupled to the third wiring during the operation on the support substrate, and
the fourth wiring is coupled to the ground during the inspection and coupled to the first wiring during the operation on the support substrate.

2. The physical quantity detection device according to claim 1, wherein
the support substrate includes
first ground wiring, and
second ground wiring, and
during the inspection, the first ground wiring is coupled to the second wiring, and the second ground wiring is coupled to the fourth wiring.

3. The physical quantity detection device according to claim 2, wherein
the support substrate has
a first cut trace between the second wiring and the first ground wiring, and
a second cut trace between the fourth wiring and the second ground wiring.

4. The physical quantity detection device according to claim 3, wherein
the first cutting trace and the second cutting trace do not overlap the physical quantity detection element in plan view.

5. The physical quantity detection device according to claim 3, wherein
the first cutting trace and the second cutting trace do not overlap the circuit device in plan view.

6. The physical quantity detection device according to claim 1, wherein
the support substrate includes
a first terminal to be coupled to the first input node of the amplifier circuit, and
a second terminal to be coupled to the second input node of the amplifier circuit,
the first terminal is coupled to the first wiring, and
the second terminal is coupled to the third wiring.

7. The physical quantity detection device according to claim 6, wherein
the second wiring is not coupled to the second terminal during the inspection, and
the fourth wiring is not coupled to the first terminal during the inspection.

8. The physical quantity detection device according to claim 1, wherein
the support substrate includes
a first pad coupled to the first wiring,
a second pad coupled to the second wiring,
a third pad coupled to the third wiring, and
a fourth pad coupled to the fourth wiring, and
during the operation, the second pad is coupled to the third pad, and the fourth pad is coupled to the first pad.

9. The physical quantity detection device according to claim 8, wherein
the second pad is coupled to the third pad by a first bonding wire, and
the fourth pad is coupled to the first pad by a second bonding wire.

10. The physical quantity detection device according to claim 8, wherein
the first pad, the second pad, the third pad, and the fourth pad do not overlap the physical quantity detection element in plan view.

11. The physical quantity detection device according to claim 8, wherein
the first pad, the second pad, the third pad, and the fourth pad do not overlap the circuit device in plan view.

12. A method of manufacturing a physical quantity detection device including a physical quantity detection element including a plurality of detection arms, a plurality of drive arms, and a base portion, a support substrate that supports the physical quantity detection element at the base portion, and a circuit device including a detection circuit that detects a physical quantity based on a plurality of detection signals from the plurality of detection arms of the physical quantity detection element,
the physical quantity detection element including, as the plurality of detection arms,
a first detection arm including a first detection electrode and a second detection electrode and extending from the base portion, and
a second detection arm including a third detection electrode and a fourth detection electrode and extending from the base portion in a direction opposite to a direction in which the first detection arm extends from the base portion,
the detection circuit of the circuit device including
an amplifier circuit in which, during operation, a first detection signal from the first detection electrode and a fourth detection signal from the fourth detection electrode are input to a first input node, and a third detection signal from the third detection electrode and a second detection signal from the second detection electrode are input to a second input node,
the support substrate including
first wiring having one end coupled to the first detection electrode,
second wiring having one end coupled to the second detection electrode,
third wiring having one end coupled to the third detection electrode, and
fourth wiring having one end coupled to the fourth detection electrode,
the method comprising:
preparing the physical quantity detection element and the support substrate;
attaching the physical quantity detection element to the support substrate;
adjusting at least one of the plurality of drive arms;
cutting coupling between the second wiring and ground and coupling between the fourth wiring and the ground; and
coupling the second wiring to the third wiring and coupling the fourth wiring to the first wiring.
